(19) United States
(12) Patent Application Publication
(10) Pub. No.: US 2014/0143721 A1
(43) Pub. Date: May 22, 2014

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Kaoru Suzuki, Yokohama-shi (JP); Yuto Yamaji, Fuchu-shi (JP); Yojiro Tonouchi, Inagi-shi (JP); Kazunori Imoto, Kawasaki-shi (JP); Yasunobu Yamauchi, Yokohama-shi (JP)

(73) Assignee: KABUSHIKI KAISHA TOSHIBA, Tokyo (JP)

(21) Appl. No.: 14/081,450

(22) Filed: Nov. 15, 2013

(30) Foreign Application Priority Data
Nov. 20, 2012 (JP) 2012-253889

(51) Int. Cl. G06F 3/0488; G06F 3/0484

(52) U.S. Cl. CPC G06F 3/0488; G06F 3/04842
USPC 715/810

(57) ABSTRACT

According to an embodiment, an information processing device associated with a display unit displaying information, includes a first detecting unit, a second detecting unit, and an executing unit. The first detecting unit is configured to detect a selection command and a first object. The selection command is input in handwriting to instruct selection of an object included in the information displayed on the display unit. The first object is additionally input in handwriting relating the information. The second detecting unit is configured to detect a second object from among objects included in the information. The second object is instructed to be selected by the selection command. The executing unit is configured to perform a specified process using the first object and the second object.

### CROSS-REFERENCE TO RELATED APPLICATION

This application is based upon and claims the benefit of priority from Japanese Patent Application No. 2012-253889, filed on Nov. 20, 2012; the entire contents of which are incorporated herein by reference.

### FIELD

Embodiments described herein relate generally to an information processing device, an information processing method, and a computer program product.

### BACKGROUND

There are known information processing devices in which a database is searched for a document that complies with a search request which is input by a user in handwriting.

### BRIEF DESCRIPTION OF THE DRAWINGS

FIG. 1 is a block diagram illustrating an information processing device according to an embodiment;

FIG. 2 is a diagram illustrating an example of detected objects;

FIG. 3 is a flowchart for explaining processes performed to detect an object;

FIG. 4 is a flowchart for explaining a shape determination process;

FIG. 5 is a flowchart for explaining a process of determining a closed loop;

FIG. 6 is an explanatory diagram for explaining a process of determining whether or not handwriting is included on the inward side of the closed loop;

FIG. 7 is an explanatory diagram for explaining a process of determining whether or not handwriting is present in the upper neighborhood of a horizontal line;

FIG. 8 is a diagram illustrating an ink data structure;

FIG. 9 is a flowchart for explaining the information processing according to the embodiment;

FIG. 10 is a flowchart for explaining an example of a stroke-analyzing and responding process;

FIG. 11 is a flowchart for explaining an object selection detecting process;

FIG. 12 is a flowchart for explaining a relationship command detecting process;

FIG. 13 is a flowchart for explaining another example of the stroke-analyzing and responding process;

FIG. 14 is a diagram illustrating an example of document data that is displayed;

FIG. 15 is a diagram illustrating the data structure of objects included in the document data;

FIG. 16 is a diagram for explaining an example of the hierarchical structure of objects;

FIG. 17 is a diagram illustrating an exemplary sequence of processes performed during a search process;

FIG. 18 is a diagram illustrating an exemplary sequence of processes performed during the search process when the input of a relationship command is omitted;

FIG. 19 is a diagram illustrating an exemplary sequence of processes performed during the search process when the input of an additional object is omitted;

FIG. 20 is a diagram illustrating an exemplary sequence of processes performed during the search process when the input of a relationship command is also omitted;

FIG. 21 is a diagram illustrating the relationship between a selection command, an area of interest, and a selected object;

FIG. 22 is a diagram illustrating an example in which a search is performed with an image object treated as the search query:

FIG. 23 is a diagram illustrating an example of the sequence followed during the search process;

FIG. 24 is a diagram illustrating another example of the sequence followed during the search process;

FIG. 25 is a diagram illustrating still another example of the sequence followed during the search process;

FIG. 26 is a diagram illustrating still another example of the sequence followed during the search process;

FIG. 27 is a diagram illustrating still another example of the sequence followed during the search process;

FIG. 28 is a diagram illustrating the data used in a search process;

FIG. 29 is a diagram illustrating an example of animation display;

FIG. 30 is a diagram illustrating another example of animation display;

FIG. 31 is a diagram illustrating an example of a screen from which unnecessary commands are erased;

FIG. 32 is a diagram illustrating the relationships between the search commands and the types of search process;

FIG. 33 is a diagram illustrating an example of outputting the search result;

FIG. 34 is a diagram illustrating another example of outputting the search result;

FIGS. 35 to 37 are diagrams for explaining new selection and reselection of an existing object;

FIG. 38 is a diagram illustrating an exemplary transition of screens when a search command is executed;

FIG. 39 is a diagram illustrating an exemplary transition of screens during a process of adding an agenda to a schedule;

FIG. 40 is a diagram illustrating an exemplary transition of screens when an annotated display is performed;

FIG. 41 is a diagram for explaining a method of changing the display mode of the annotated display; and

FIG. 42 is a hardware configuration diagram of the information processing device according to the embodiment.

### DETAILED DESCRIPTION

According to an embodiment, an information processing device associated with a display unit displaying information, includes a first detecting unit, a second detecting unit, and an executing unit. The first detecting unit is configured to detect a selection command and a first object. The selection command is input in handwriting to instruct selection of an object included in the information displayed on the display unit. The first object is additionally input in handwriting relating the information. The second detecting unit is configured to detect a second object from among objects included in the information. The second object is instructed to be selected by the selection command. The executing unit is configured to perform a specified process using the first object and the second object.

An exemplary embodiment of an information processing device according to the invention is described below in detail with reference to the accompanying drawings.

In the case of performing a search in a touch-sensitive panel display terminal such as a smartphone, it is common practice to implement the following method: a window for inputting a search query is tapped and the cursor is moved; a character string is typed in with the use of a software keyboard that is displayed; and a search button is tapped. Alternatively, there are some terminals in which a window that enables writing of handwritten characters appears as substitute for the software keyboard. Then, the stroke data that is input in handwriting is recognized and is converted into a character string that is treated as a search query. However, in such methods, from inputting a search query up to performing a search, it is necessary to perform a sequence of processes such as moving the cursor, inputting the search query string, and pressing the button. Not only that, depending on the search target, a different search query needs to be input.

As a known example of simplifying the process of inputting a search query, the search is performed while treating an already-displayed character string as the search query. For example, a technology is known in which document data is displayed on a display screen and, when a character string in that document data is selected on the display screen, the information related to that character string is immediately displayed without the need to press the search button. As far as the method of selection at that time is concerned, the cursor of a pointing device is used to trace over a character string that is displayed. However, in this method, the search is performed immediately after the search query is selected. For that reason, not only it is not possible to specify a search target but also it is not possible to perform annotation (described later) at the same time.

With the popularization of pen tablet terminals in recent years, there has been development of applications that enable handwriting of character strings or pictures on a screen which represents a notepad or a sketchbook, or applications that enables displaying existing document data on a screen and enables writing of notes by hand on that screen. Particularly, the latter application enables marking an object (a character string or an image), which is present in the document data and which is considered important by the user, by encircling or underlining that object. Moreover, it also becomes possible to write lead lines or annotations in the vicinity of that object. In this way, regarding the case of displaying the document data and enabling the user to perform a writing process, such as encircling or underlining an object in the document data, on the display; the intention is to memorize (annotating) that object by differentiating it from other objects. Subsequently, if a character string or the like is written in the vicinity of that object; then the encircling/underlining and the written information collectively represents annotation information with respect to that object.

Meanwhile, as described in the example given above, when the user wants to perform some kind of a search while using a particular object in the document data as the search query, then it is an extremely natural thing to select that particular object by encircling or underlining it. However, such a writing process on its own cannot be distinguished from the abovementioned annotation intention. Thus, in order to distinguish between the two, it becomes necessary to perform some kind of an additional input. In the case when the user follows encircling or the like by performing an additional input as part of the writing process, it becomes necessary to distinguish between the annotation intention and the search intention depending on the written contents.

In an information processing device according to an embodiment, a new method is provided that enables the user to perform a search by selecting, from the information (a document) displayed on a display unit, an object that is to be treated as the search query (i.e., by selecting a search query object). More particularly, from among the contents written by the user, the information processing device according to the embodiment detects commands such as a selection command, a relationship command, and a search command. A selection command is used as an instruction to select an object that is to be processed. For example, the selection command is issued in the form of encircling or underlining. A relationship command is used as an instruction to relate a plurality of objects. For example, the relationship command is issued in the form of a lead line or an arrow starting from an object. A search command is used as an instruction to perform a search process. For example, the search command is in the form of a character string that represents specific patterns such as “?”, “search over WEB”, “What is the English translation?”, “What is the meaning?”, and “What are the synonyms?”.

Moreover, in the embodiment, a method is provided to enable dealing with a search command which can be issued with respect to different search targets in an individual manner or in a collective manner, and to enable dealing with the search result of the search. More particularly, the following commands are made available as search commands: “all-target search”, “full command”, and “simplified command”. Moreover, a framework is provided in such a way that the search targets corresponding to each command can be searched in an independent manner or in combination. At that time, the search result is organized on the basis of the search targets and is presented to the user. Herein, the all-target search points to the overall search performed using the selected object. If the selected object represents handwritten characters, then it is possible to search for the characters that are similar to the handwritten characters. Alternatively, the search may be performed after recognizing the text of the handwritten characters, or the search may be performed with respect to the document that contains similar text. If the selected object represents an image, then it is possible to search for the similar image or to search for information belonging to the similar image. In such cases, the search target is dependent on the system. Meanwhile, the user may register in advance the search targets, and may put predetermined restrictions on the search.

Herein, by implementing an instinctive and expeditious method of writing a selection command, a relationship command, or a search command on the displayed document; it becomes possible for the user to specify a search query and perform a search for the information related to that search query. At that time, by changing the search command to be written, it becomes possible to perform a search for different search targets in an independent manner or in combination.

Meanwhile, in the embodiment, the explanation is given for an example in which a search process is performed while treating mainly objects as the search query. However, the application of the embodiment is not only limited to the search process. That is, the embodiment may be applied to any process in which specified objects are used. For example, as described later, the embodiment may be applied to a process of registering a specified object in a schedule. In the case of applying the embodiment to a process other than the search process, the abovementioned search command may be replaced with a run command of that particular process.

In the embodiment, the document displayed on a display unit may or may not be a handwritten document. A handwritten document contains, for example, data of handwriting (described later). A non-handwritten document is a document (such as text data) that includes, for example, data expressed in character codes. The text data may be obtained by, for example, performing character recognition with respect to an image that is obtained by capturing a handwritten document using an optical scanner or a camera.

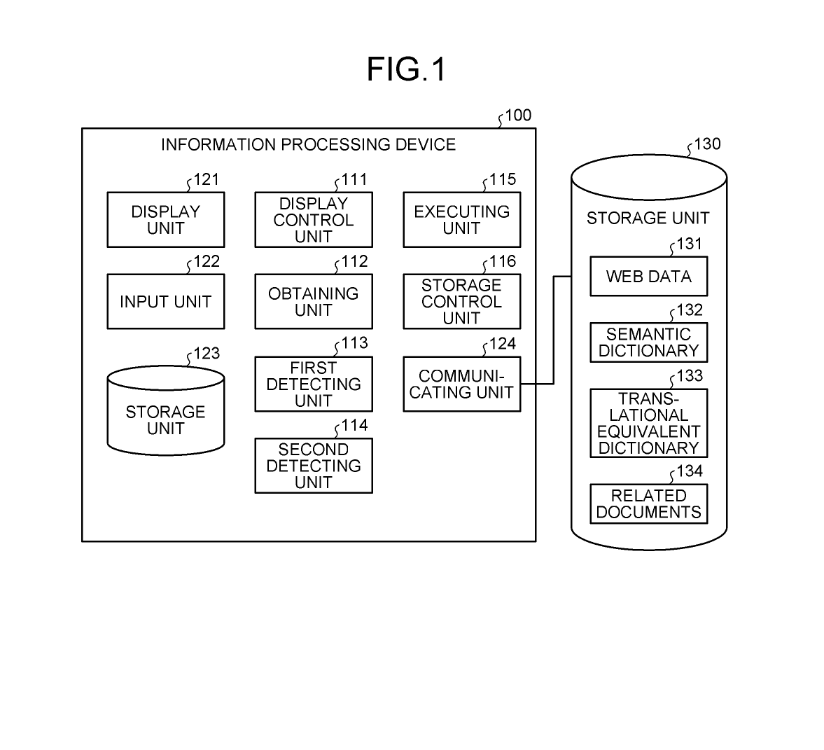

FIG. 1 is a block diagram illustrating an exemplary configuration of an information processing device 100 according to the embodiment. As illustrated in FIG. 1, the information processing device 100 includes a display unit 121, an input unit 122, a storage unit 123, a communicating unit 124, a display control unit 111, an obtaining unit 112, a first detecting unit 113, a second detecting unit 114, an executing unit 115, and a storage control unit 116.

The display unit 121 displays thereon a variety of information. Herein, the display unit 121 may be configured using a touch-sensitive display.

The input unit 122 receives input of various instructions. Herein, the input unit 122 may be configured using a combination of one or more of, for example, a mouse, buttons, a remote control, a keyboard, a voice data recognizing device such as a microphone, and an image recognizing device.

Meanwhile, the display unit 121 and the input unit 122 may also be configured in an integrated manner. For example, the display unit 121 and the input unit 122 may be configured as a user interface (UI) unit that has a display function as well as an input function. The UI unit is, for example, a liquid crystal display (LCD) equipped with a touch-sensitive panel.

The storage unit 123 is used to store a variety of information. Herein, the storage unit 123 may be configured using any kind of a commonly-used storage medium such as a hard disk drive (HDD), an optical disk, a memory card, or a random access memory (RAM).

The communicating unit 124 performs communication with an external device. The communicating unit 124 is connected to, for example, a storage unit 130 that is installed on the outside of the information processing device 100. The storage unit 130 is used to store, for example, information on search targets such as WEB data 131, semantic dictionary 132, translational equivalent dictionary 133, and related documents 134. Herein, the related documents 134 represent a set of documents that are categorized into predetermined categories. Alternatively, the related documents 134 may represent a set of documents that are categorized according to user-defined categories. For example, the related documents 134 may represent a set of related documents that compiles handwritten documents, or may be a set of related documents of different categories. Regarding a search with respect to handwritten characters, it is possible to search for similar characters or similar documents from among handwritten documents that have been recognized online. Meanwhile, in FIG. 1, only a single storage unit 130 is illustrated. However, the storage unit 130 may be divided into a plurality of physically different storage devices.

The information on search targets may either be in the form of handwritten documents or be in the form of non-handwritten documents such as text data. In preparation for the case of performing a search with respect to a handwritten document, the storage unit 130 may include a handwritten document database (DB) (not illustrated).

The display control unit 111 controls the display of information on the display unit 121. For example, the display control unit 111 displays document data, which has been input, on the display unit 121. Moreover, the display control unit 111 displays stroke data, which is input in handwriting, on the display unit 121. As described later, the display control unit 111 performs control to change the display mode of the displayed data depending on various timings such as a timing before performing the processes, a timing during the processes, and a timing after performing the processes.

The obtaining unit 112 obtains data of handwriting via the input unit 122. Herein, the data of handwriting obtained by the obtaining unit 112 contains time-series data of the coordinates that are separated on a stroke-by-stroke basis. For example, the data of handwriting is expressed in the following manner.

Stroke 1: (x(1, 1), y(1, 1), x(1, 2), y(1, 2), . . . , (x(1, N(1)), y(1, N(1)))

Stroke 2: (x(2, 1), y(2, 1)), (x(2, 2), y(2, 2)), . . . , (x(2, N(2)), y(2, N(2)))

. . .

Herein, N(i) represents the number of points at the time of sampling a stroke i. Meanwhile, the handwritten documents stored in the handwritten document DB also contain the data of handwriting.

The first detecting unit 113 determines the shape of handwriting, which is obtained by the obtaining unit 112, based on the coordinate data of that handwriting; and detects the object that was input in handwriting. Each of the abovementioned commands such as the selection command, the relationship command, and the search command corresponds to an object detected in this fashion. As far as a character string other than the abovementioned commands is concerned, the first detecting unit 113 detects that character string as an additional object (a first object).

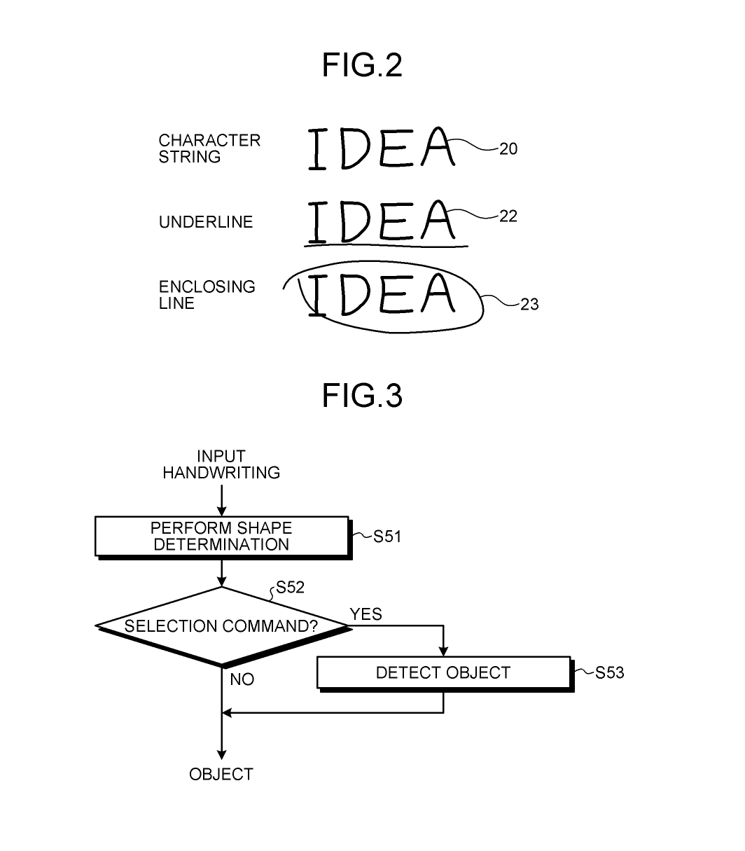

FIG. 2 is a diagram illustrating an example of detected objects. In FIG. 2, a character string, an underline, and an enclosing line are illustrated as exemplary objects. These objects are categorized according to the shape of handwriting. An object 20 is a character string object that represents, for example, a character string “IDEA” input in handwriting (or selected from a displayed document). Herein, it is needless to say that the contents of a character string are not limited to “IDEA” and may be set arbitrarily. An object 22 is an underline object. It is often the case that an underline is drawn with the aim of highlighting a character string. An object 23 is an enclosing line object such as a round enclosing line or a quadrilateral enclosing line. An enclosing line is drawn with the aim of highlighting a character string in an identical manner to an underline, and with the aim of distinguishing a particular character string from other character strings.

The second detecting unit 114 detects an object (a second object) that has been selected from the displayed information. For example, the second detecting unit 114 detects, from the displayed document data, an object (a second object) that is selected according to a selection command.

Explained below with reference to a flowchart illustrated in FIG. 3 are the specific processes performed to detect an object.

Firstly, the shape of handwriting that has been input is determined (Step S51). The first detecting unit 113 refers to the coordinate data included in the data of handwriting that is obtained as input by the obtaining unit 112, and determines the shape of that handwriting so as to detect objects such as character string objects, underline objects, and enclosing line objects. Meanwhile, the shape of an object is not limited to the abovementioned shapes. Alternatively, for example, lead lines or arrows other than underlines may also be detected. Herein, lead lines or arrows may be detected as objects representing relationship commands.

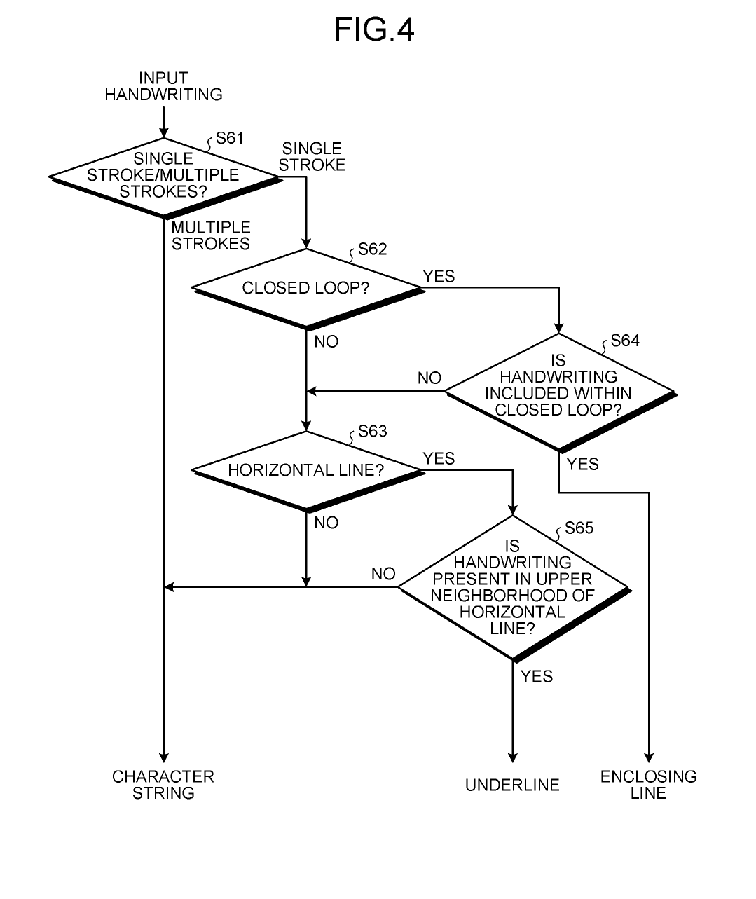

FIG. 4 is a flowchart for explaining a shape determination process, which is performed based on the coordinate data of the handwriting obtained by the obtaining unit 112.

With reference to FIG. 4, the first detecting unit 113 determines whether or not the input handwriting has a single stroke (Step S61). If the input handwriting has a single stroke (Single Stroke at Step S61); then the first detecting unit 113 determines whether or not that single-stroke handwriting forms a closed loop (Step S62). The process of determining a closed loop is explained with reference to FIG. 5. The first detecting unit 113 determines whether or not polygonal lines P[1], P[2], . . . , P[n−1], and P[n] are closed curves. The line segment of each polygonal line is expressed as L[i]=P[i]P[i+1]. The first detecting unit 113 checks whether or not L[i]: and L[j] (i<j) intersect with each other. If L[i] and L[j] (i<j) intersect with each other, then the first detecting unit 113 determines that P[i], . . . , P[j+1] form a closed curve. For example, in the example illustrated in FIG. 5, a line segment L[2] and a line segment L[7] intersect with each other. Thus, P[2], . . . , P[8] form a closed curve. In addition, the first detecting unit 113 calculates the distance between the start point P[0] to the end point P[8] of the stroke (stroke data of the single stroke). If the calculated distance is smaller as compared to the total length of the stroke, then the first detecting unit 113 determines that a closed loop is formed. Thus, if the single-stroke handwriting forms a closed loop (Yes at Step S62), then the first detecting unit 113 determines whether or not the handwriting is included on the inward side of the closed loop (Step S64).

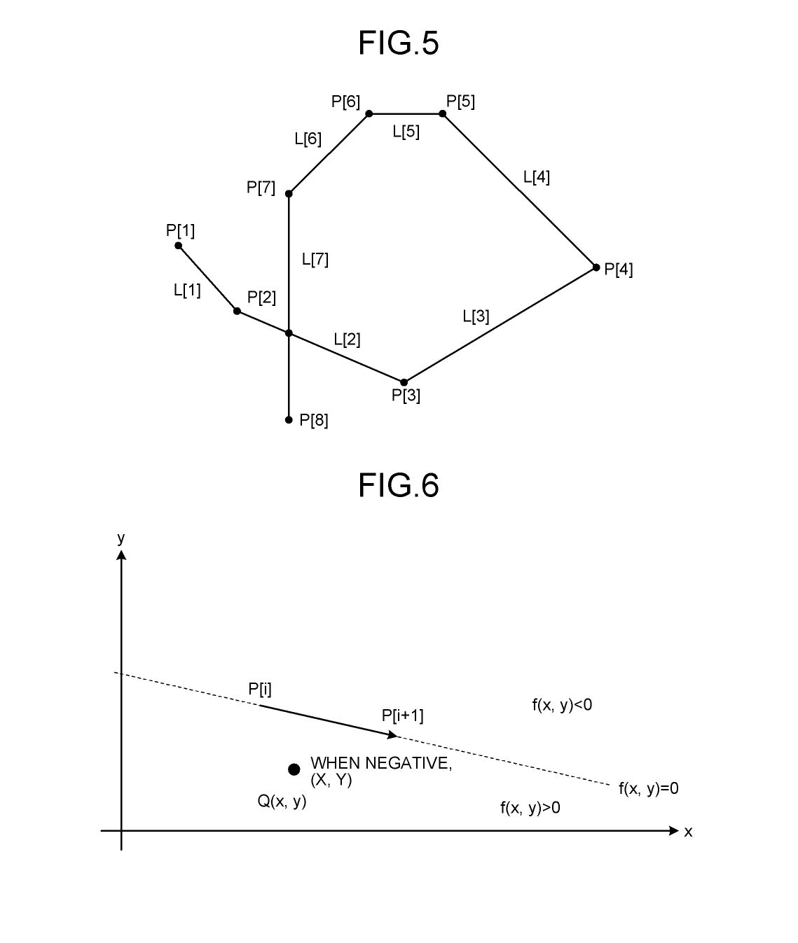

The process of determining whether or not the handwriting is included on the inward side of the closed loop is explained with reference to FIG. 6. Regarding the target handwriting for determination, if all points Q[1], Q[2] Q[M] thereof are within a closed loop curve; then the first detecting unit 113 determines that the handwriting is included within the closed loop. Moreover, whether or not a point Q is included in a closed loop can be determined in the following manner. Assume that P[1](X[1], Y[1]), P[2](X[2], Y[2]), . . . , P[N−1](X[N−1], Y[N−1]) constitute a closed loop curve and assume that Q(X, Y) represents the target point for determination.

(1) A straight line f[i](x, y)=0 that passes through two points P[i] and P[i+1] is calculated as

f(x,y)=(Y[i+1]−Y[i])*(x−X[i])−(X[i+1]−X[i])*(y−[Y[i]])=0.

However, if i=N is satisfied, then the straight line f[N] passing through two points P[N] and P[0] becomes f[N](x, y)=0.

(2) The side of Q(X, Y) with respect to the direction of movement of the straight line is determined. For that, f[i](X, Y) is calculated. If that value is positive, then Q(X, Y) is on the right-hand side with respect to the direction of movement of the straight line. On the other hand, if that value is negative, then Q(X, Y) is on the left-hand side with respect to the direction of movement of the straight line.

(3) The processes at (1) and (2) are repeated with respect to each “i”, and if the same sign is obtained for Q(X, Y) in all straight lines f[i](X, Y); it is determined that the point Q is on the inward side of the closed loop.

If it is determined that the handwriting is included on the inward side of the closed loop (Step S64), then the first detecting unit 113 detects an “enclosing line” as the object. In this case, the first detecting unit 113 can detect an “enclosing line” as an object indicating a selection command.

Meanwhile, if it is determined that a closed loop is not formed (No at Step S62 or No at Step S64), then the first detecting unit 113 determines whether or not the single stroke of handwriting is a horizontal line (Step S63). For example, the first detecting unit 113 solves a known linear regression problem and applies straight lines to a polygonal line. If the regression error obtained by that process is within a threshold value, then the first detecting unit 113 determines the polygonal line to be a straight line. When the polygonal line is determined to be a straight line; if the absolute value of the slope of the straight line is equal to or smaller than a predetermined value, then the first detecting unit 113 determines that the straight line is oriented sideways. If the straight line is determined to be a horizontal line (Yes at Step S63), then the first detecting unit 113 determines whether or not handwriting is present in the upper neighborhood of the horizontal line (Step S65).

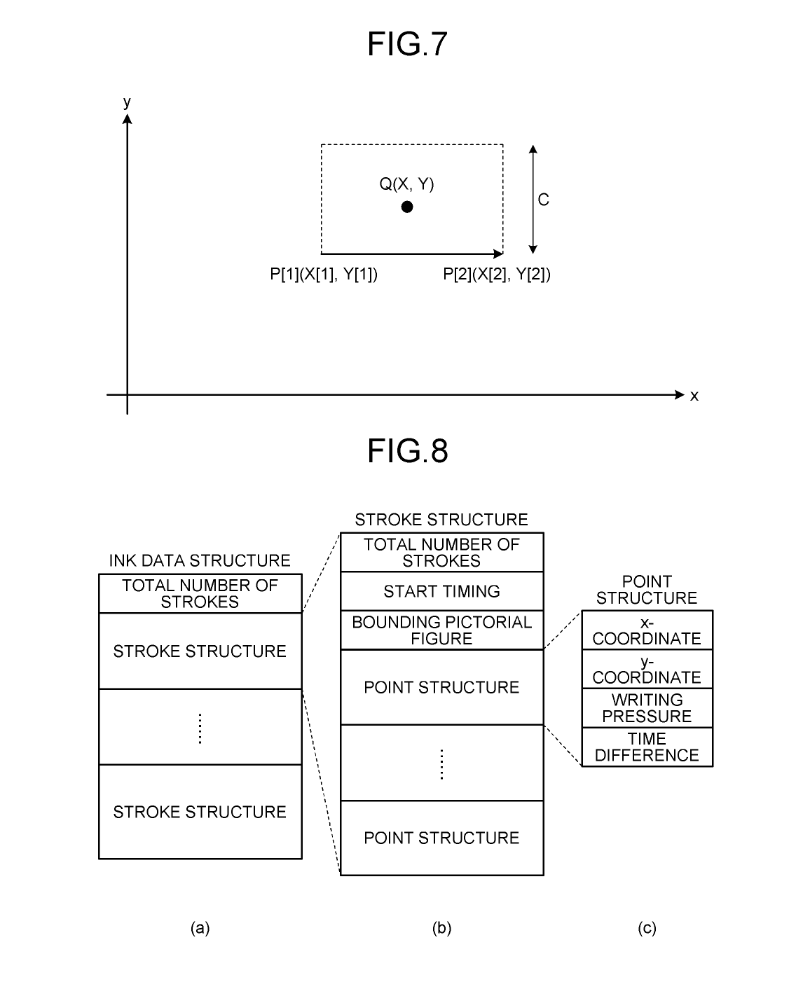

The process of determining whether or not handwriting is present in the upper neighborhood of the horizontal line is explained with reference to FIG. 7.

If all points Q[1], Q[2], . . . , Q[M] of the target handwriting for determination are present in the upper neighborhood of the line segment, then the first detecting unit 113 determines that handwriting is present in the upper neighborhood of the horizontal line. Whether or not a point Q is present in the upper neighborhood of the horizontal line can be determined in the following manner. Assume that P[1](X[1], Y[1]) and P[2](X[2], Y[2]) constitute a line segment; X[1]<X[2] is satisfied; and Q(X, Y) represents the target point for determination. Then, if the following four expressions are simultaneously satisfied, then the point Q can be determined to be present in the upper neighborhood of the horizontal line.

X[1]<X

X<X[2]

Y>(Y[1]+Y[2])/2

Y<(Y[1]+Y[2])/2+C,

where C is a predetermined threshold value.

When it is determined that handwriting is present in the upper neighborhood of the horizontal line (Yes at Step S65), the first detecting unit 113 detects an “underline” as the object. In this case, the first detecting unit 113 can detect an “underline” as an object indicating a selection command.

Meanwhile, if it is determined that a horizontal line is not present (No at Step S63 or No at Step S65) as well as if it is determined that the input handwriting has a plurality of strokes (Multiple Strokes at Step S61); then the first detecting unit 113 detects a “character string” as the object. If the detected “character string” is a specific character string, then the first detecting unit 113 can detect that character string as an object indicating a search command. For example, if the “character string” is “search over WEB”, then the “character string” can be detected as an object indicating a search command.

Returning to the explanation with reference to FIG. 3, the first detecting unit 113 determines whether or not the detected object is a selection command (Step S52). If the detected object is not a selection command (No at Step S52), then the first detecting unit 113 outputs the detected object as well as outputs the input data of handwriting without modification. On the other hand, if the detected object is a selection command (Yes at Step S52), then the second detecting unit 114 detects, from the displayed document, the object that is selected according to the selection command (Step S53). For example, in the case when the selection command is an “enclosing line”, the second detecting unit 114 detects and outputs an object such as a character string from the area in the document that is enclosed by the “enclosing line”.

Meanwhile, if the displayed document is a handwritten document, then the second detecting unit 114 can detect the data of handwriting of the portion that is instructed in the selection command. Similarly, if the displayed document is a non-handwritten document such as text data, then the second detecting unit 114 can detect text data of the portion that is instructed in the selection command.

Then, the object that is detected in this way is sent to the executing unit 115. Meanwhile, the abovementioned method of detection implemented by the first detecting unit 113 is only exemplary. That is, it is not the only possible method. As long as an object such as a sign or a character string that is input in handwriting is detected, any method may be implemented. Similarly, the abovementioned method of detection implemented by the second detecting unit 114 is only exemplary. That is, it is not the only possible method. As long as the object selected from the displayed information is detected, any method may be implemented.

The executing unit 115 performs processes using the detected object. For example, when a search command is detected, the executing unit 115 performs a search process in which at least the object selected in the selection command is treated as the search query.

The search target is information that can be cross-checked and retrieved using a character code string and data of handwriting.

In the case when text data other than a handwritten document is the search target; the executing unit 115 performs a search process in which, for example, the text data corresponding to the detected object is treated as the search query. If the detected object represents handwritten characters, then the executing unit 115 can perform character recognition with respect to the handwritten characters, convert the handwritten characters into text data, and treat the text data as the search query.

In the case when a handwritten document is the search target; the executing unit 115 performs a search process in which, for example, the data of handwriting corresponding to the detected object is treated as the search query. More particularly, in the handwritten document DB, a search is performed for the handwriting that is similar to or matches with that character string.

Given below is the explanation of a specific example of a process of searching in the handwritten document DB for the handwriting that is similar to or matches with a character string search query. The executing unit 115 performs, for example, feature vector matching and searches for a stroke sequence that is similar to the stroke sequence representing the handwriting of the search query. An exemplary concrete structure of the stroke data (data of handwriting) is explained with reference to FIG. 8.

Herein, “stroke” points to a stroke that is input in handwriting, and represents the locus from the time when a pen or the like makes contact with the input screen until it is lifted from the input screen. Usually, the points on the locus are sampled at predetermined timings (for example, at constant periods). Hence, a stroke is expressed as a series of the sampled points.

In the example illustrated in (b) in FIG. 8, the stroke structure of a single stroke is expressed as a set of coordinate values on the plane on which a pen is moved (i.e., expressed as a point structure). More particularly, the stroke structure includes an array of “total number of points” that indicates the number of points constituting the stroke, “start timing”, “bounding pictorial figure”, and “point structure” equivalent to the total point count. Herein, the start timing indicates the timing at which the pen makes a contact with the input screen and the stroke is written. The “bounding pictorial figure” represents the bounding pictorial figure with respect to the locus of the stroke on the document plane (desirably, represents the rectangle of minimal area that includes the stroke on the document plane).

The structure of points may be dependent on the input device. In the example illustrated in (c) in FIG. 8, the structure of a single point has the following four values: the x-coordinate value at which that point is sampled; the y-coordinate value at which that point is sampled; the writing pressure; and the time difference from the initial point. Herein, for example, the abovementioned “start timing” represents the initial point.

Meanwhile, coordinates represent the coordinate system of the document plane. For example, with the upper left corner as the origin, the coordinate values may be expressed as positive values that go on increasing toward the lower right corner.

In the case when the input device cannot obtain the writing pressure or in the case when, although the writing pressure is obtained, it is not used in subsequent processes; the writing pressure may be omitted from (c) illustrated in FIG. 8. Alternatively, data indicating invalidity of the writing pressure may be written.

Meanwhile, in the examples of (b) and (c) in FIG. 8, in the areas of individual point structures that are present in the stroke structure, the actual data such as the x-coordinate value and the y-coordinate value in the input device may also be mentioned. Alternatively, the stroke structure data and the point structure data may be managed in an individual manner. In that case, in the areas of individual point structures present in the stroke structure, link information with respect to the respective point structures can be written.

As a specific example of feature vector matching at the time of searching for a stroke sequence that is similar to the stroke sequence representing handwriting of a search query; it is possible to implement, for example, the dynamic program (DP) matching technique. Meanwhile, the stroke count of the stroke sequence specified by the user may not necessarily match with the stroke count of the stroke sequence desired by the user. That is because, there is a possibility that the character strings having the same meaning are written with different stroke counts by different writers. For example, depending on the writer, two strokes of the same character may be written in only a single stroke. For example, by implementing the DP matching technique that takes into account the correspondence between a single stroke and N number of strokes, it becomes possible to perform matching that is robust against the variation in strokes (for example, see Masuda, Uchida, Sakoe, “Experimental Optimization for DP Matching for On-Line Character Recognition”, Joint Conference of Electrical and Electronics Engineers in Kyushu, 2005, retrieved from http://human.ait.kyushu-u.ac.jp/˜uchida/Papers/masuda-shibu2005.pdf).

For example, each stroke included in the target stroke sequence for matching is considered to be the start point; mapping of the stroke sequence that is a user-specified search query is performed; and the degree of similarity between stroke sequences is calculated. Then, after calculating the degree of similarity from each start point; the degrees of similarity are sorted in descending order. Since each stroke is considered to be the start point, a result is obtained that includes overlapping. Subsequently, peak detection is performed and each range of overlapping strokes is integrated.

Meanwhile, other than the matching technique described above, various other matching techniques may also be implemented.

The storage control unit 116 controls the process of storing information in the storage unit 123.

Meanwhile, the display control unit 111, the first detecting unit 113, the executing unit 115, and the storage control unit 116 may be implemented by running computer programs in a processing unit such as a central processing unit (CPU), that is, may be implemented using software; or may be implemented using hardware such as an integrated circuit (IC); or may be implemented using a combination of software and hardware.

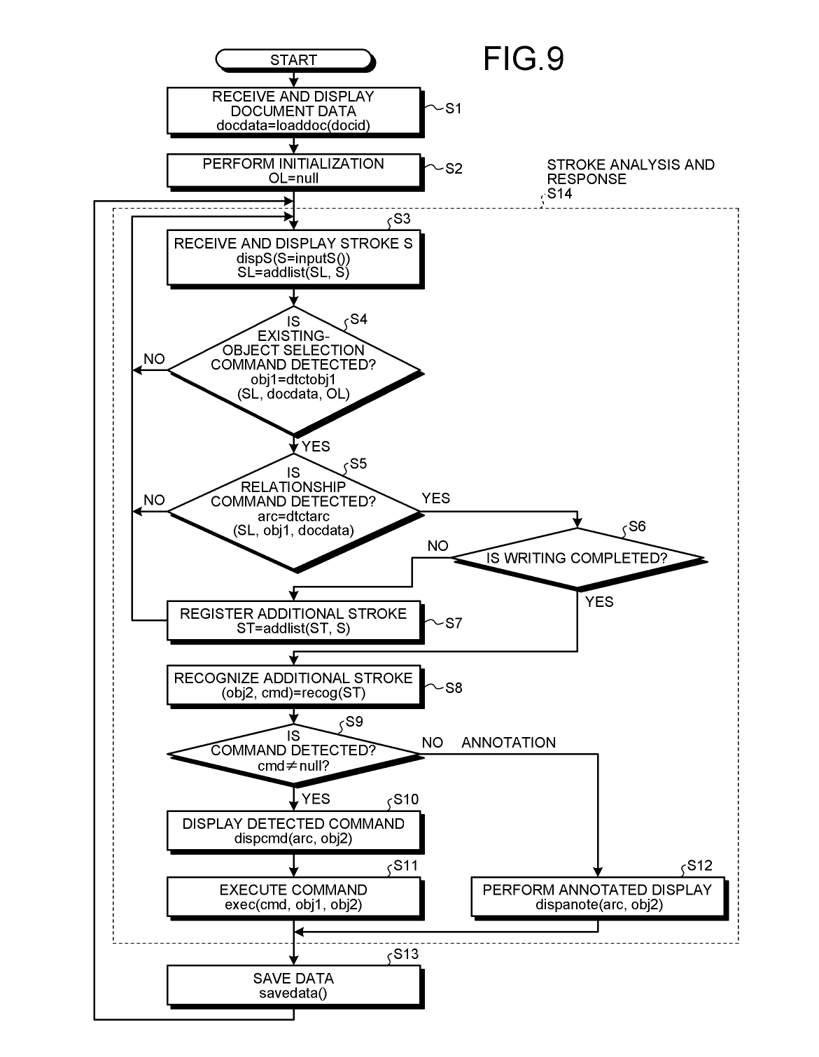

Explained below with reference to FIG. 9 is the information processing performed in the information processing device 100 configured in the abovementioned manner according to the embodiment. FIG. 9 is a flowchart for explaining an example of the information processing according to the embodiment.

Firstly, the explanation is given about the definitions of parameters and functions that are referred to in the flowchart illustrated in FIG. 9.

Parameters

docid: A document ID (given)

docdata: The document data corresponding to docid that has been input

OL: A list of existing objects in docdata that have been selected till now (used in reselection)

null: An empty state of a list

S: A single set of stroke data that has been input

SL: A list of strokes S (equivalent to the above-mentioned stroke sequence)

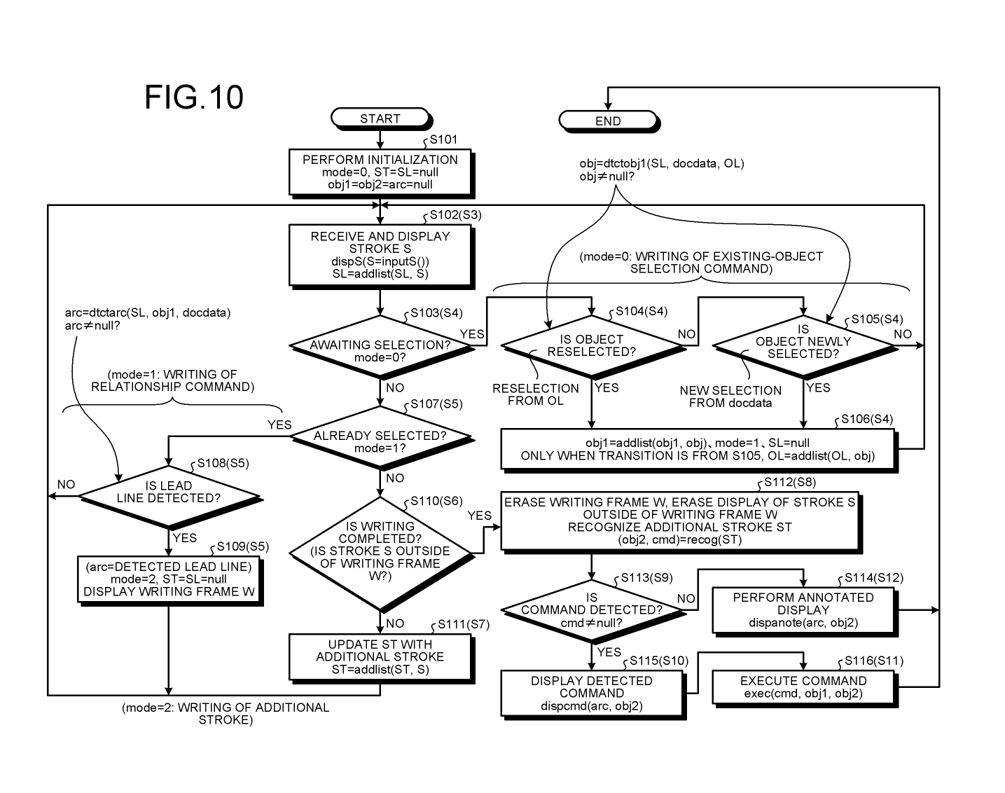

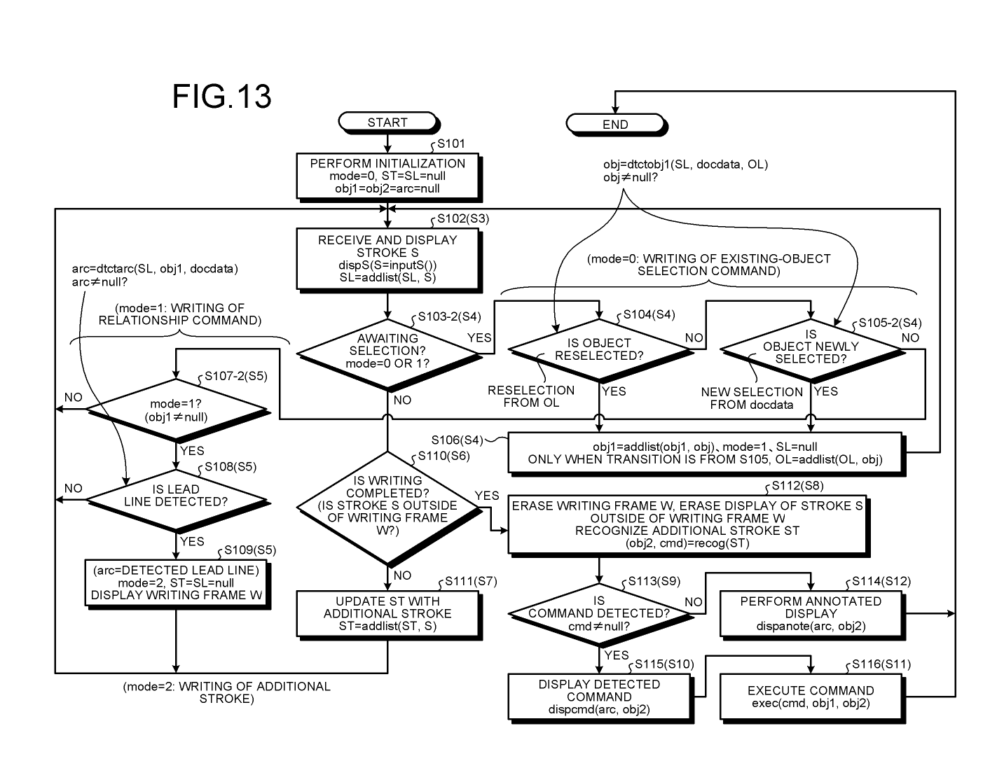

obj1: A list of existing objects that have been selected (in FIG. 10 (described later), a single object; in FIG. 13 (described later), a plurality of objects is allowed)

arc: A relationship command (such as a lead line) that is written

ST: A list of additional strokes that are written

obj2: An additional object other than docdata and written as an additional stroke

cmd: A command written as an additional stroke, and including a search command or an agenda addition command.

mode: An internal control mode. In the following explanation, mode 1 indicates writing (detection) of an existing-object selection command; mode 2 indicates writing (detection) of a relationship command; and mode 3 indicates writing (detection) of additional strokes.

Functions

loaddoc( ): A function for receiving input of document data. The function loaddoc( ) reads the document data specified in docid and returns a docdata class instance. format: docdata=loaddoc(docid).

inputS( ) A function for receiving input of a single set of stroke data. The inputS( ) receives input of a single stroke that starts when a pen is touched down and ends when the pen is lifted; and returns an S class instance. format: S=inputS( ).

dispS( ): A function for displaying the stroke S. format: dispS(S).

dtctobj1( ): A function for analyzing SL and detecting the selection of existing objects in docdata. In response to detection, the function dtctobj1( ) returns an obj class instance. In response to no detection, the function dtctobj1( ) returns null. format: obj=dtctobj1(SL, docdata, OL).

dtctarc( ): A function for analyzing SL and detecting a relationship command. format: arc=dtctarc(SL, obj1, docdata).

addlist( ): A function for additionally registering data in a list. format: list=addlist(list, data).

recog( ): A function for recognizing an additional stroke ST, extracting obj2 and cmd, and returning a class instance. If no additional stroke ST is recognized, the function recog( ) sets obj2 and cmd to null. format: (obj2, cmd)=(recog(ST).

dispanote( ): A function for performing annotated display. format: dispanote(arc, obj2).

dispcmd( ): A function for displaying the detected command. format: dispcmd(arc, obj2).

exec( ): A function for executing cmd that has obj1 and obj2 as arguments. format: exec(cmd, obj1, obj2).

savedata( ): A function for saving data.

With reference to FIG. 9, the display control unit 111 receives input of the document data that is to be displayed according to a user specification (docdata=loaddoc(docid)), and displays the document data on the display data (Step S1). Then, the first detecting unit 113 initializes the list OL of objects (OL=null) (Step S2). Subsequently, a stroke-analyzing and responding process is performed in which the input stroke (input handwriting) is analyzed and a response according to the analysis result is sent (Step S14). During the stroke-analyzing and responding process performed at Step S14, the following processes from Step S3 to Step S12 are performed.

Firstly, the obtaining unit 112 receives input of the stroke S and displays the stroke S on the display unit 121 (dispS(S=inputS( ), SL=addlist(SL, S)) (Step S3). Then, the first detecting unit 113 determines whether or not an existing-object selection command is detected (Step S4). Herein, an existing object indicates an object that is included in the document data that is displayed. When an existing-object selection command is detected, the second detecting unit 114 makes use of, for example, obj1=dtctobj1(SL, docdata, OL); and detects the existing object obj1 selected according to the selection command from the displayed document data (docdata). If any existing object is reselected from the list OL that is used to store the already-selected and existing objects, then the second detecting unit 114 detects the specified (selected) object from the list OL.

Meanwhile, if no existing-object selection command is detected (No at Step S4); then the system control returns to Step S3 and the processes are repeated. On the other hand, if an existing-object selection command is detected (Yes at Step S4), then the first detecting unit 113 determines whether or not a relationship command is detected (Step S5). For example, the first detecting unit 113 determines whether an object arc that is detected using arc=dtctarc(SL, obj1, docdata) represents a relationship command.

If no relationship command is detected (No at Step S5), then the system control returns to Step S3 and the processes are repeated. On the other hand, if a relationship command is detected (Yes at Step S5); then the first detecting unit 113 determines whether or not writing of the additional stroke has completed (Step S6). For example, if the stroke S is written in an area other than a writing frame that is used to write additional strokes, then the first detecting unit 113 determines that writing of the additional stroke has completed. However, determination of whether or not writing has completed is not limited to this method. For example, if data of handwriting cannot be obtained for a predetermined period of time after the pen was lifted, then the first detecting unit 113 may determine that writing has completed.

If writing has not completed (No at Step S6), then the first detecting unit 113 registers the additional stroke (ST=addlist(ST, S)) (Step S7). Then, the system control returns to Step S3 and the processes are repeated.

When writing has completed (Yes at Step S6), the first detecting unit 113 recognizes the additional stroke ((obj2, cmd)=recog(ST)) (Step S8).

Herein, as described above, recognizing a stroke means determining the shape of handwriting based on the coordinate data of handwriting (with reference to FIG. 9, based on the list of additional strokes that are written) and accordingly detecting an object. If it is determined that the detected object corresponds to a particular command, then the first detecting unit 113 sets the determined command in cmd. For example, if objects such as “?” and “search over WEB” are detected from the shape of an additional stroke, the first detecting unit 113 determines that the objects correspond to a search command and sets those objects in cmd.

However, if a detected object is determined to represent a character string other than a command, then the first detecting unit 113 sets that object in obj2. For example, if an object such as “DOMESTIC” that does not correspond to any particular command is detected from the shape of an additional stroke, then the first detecting unit 113 sets that object in obj2. During a search, this object (the additional object) is treated as, for example, the search query for adding to the existing object obj1.

The executing unit 115 determines whether or not a command is detected (Step S9). If a command is detected (Yes at Step S9), then the executing unit 115 displays that command on the display unit 121 (dispcmd(arc, obj2)) (Step S10). For example, on the display unit 121, the executing unit 115 displays the relationship command arc that has been detected and the additional object obj2 that has been detected.

Then, the executing unit 115 executes the detected command according to, for example, a user instruction to execute the command (exec(cmd, obj1, obj2)) (Step S11). For example, when a search command is detected, the executing unit 115 performs a search process using a search query that includes obj1 and obj2. At that time, obj1 represents the second object mentioned above, and obj2 represents the first object mentioned above.

Meanwhile, if no command is detected (No at Step S9), then the executing unit 115 determines that the object detected from the additional stroke represents an annotation and performs an annotated display (dispanote(arc, obj2)) (Step S12). For example, the executing unit 115 issues a request to the display control unit 111 to display on the display unit 121 the relationship command arc that is detected and the additional object obj2 that is detected.

Then, the executing unit 115 saves the data of the detected object in the storage unit 123 (savedata( )) (Step S13). That marks the end of the processes. The saved data is then used by the user at the time of, for example, referring to the history of past handwritten input. Meanwhile, the destination for saving the data is not limited to the storage unit 123. Alternatively, the data may be saved in an external device such as the storage unit 130. For example, firstly the data may be saved in the storage unit 123, and then that data may be transferred (or copied) to an external device such as the storage unit 130 at a predetermined timing.

In FIG. 9, an example is illustrated in which the executing unit 115 executes a command if an object (such as a command) is detected in the following order: (1) an existing object is selected; (2) a relationship command is detected; and (3) a command due to an additional stroke is detected. However, the conditions and the timings for executing commands are not limited to this case. Alternatively, for example, consider a case in which no relationship command is detected (No at Step S5) but an object is detected in the following order: (1) an existing object is selected and (2) a command due to an additional stroke is detected. In that case, a command may be executed using the existing object that is selected. The explanation regarding the command execution timing is given later in detail.

Given below is the more detailed explanation of the stroke-analyzing and responding process performed at Step S14 illustrated in FIG. 9. FIG. 10 is a flowchart for explaining an example of stroke-analyzing and responding process. Herein, in FIG. 10, the bracket illustrated along each step includes the corresponding step number in FIG. 9.

Firstly, the obtaining unit 112 initializes each parameter (mode=0, ST=SL=null, obj1=obj2=arc=null) (Step S101). The process at Step S102 is identical to Step S3 illustrated in FIG. 9.

Then, the first detecting unit 113 determines whether or not the mode is a selection wait mode (mode=0), that is, determines whether or not the detection of a selection command is awaited (Step S103). If the mode is a selection mode (Yes at Step S103), then the first detecting unit 113 determines whether or not an object is reselected (Step S104). Herein, the reselection of an object indicates selection of an existing object from the list OL that is used to store the already-selected and existing objects. If an object is not reselected (No at Step S104), then the first detecting unit 113 determines whether or not an object is newly selected (Step S105). Herein, new selection of an object indicates newly selecting an object from the displayed document data (docdata). If an object is not newly selected, then the system control returns to Step S102 and the processes are repeated.

Meanwhile, if an object is reselected (Yes at Step S104) or if an object is newly selected (Yes at Step S105), then the first detecting unit 113 adds the newly-selected object obj to the list obj1 of selected objects (obj1=addlist(obj1, obj) (Step S106). Moreover, the first detecting unit 113 updates the mode to an already-selected mode (a relationship command wait mode) (mode=1). Furthermore, the first detecting unit 113 initializes the list SL of strokes (SL=null). In the case of transition from Step S105, the first detecting unit 113 adds the newly-selected object obj to the list OL of selected and existing objects (OL=addlist(OL, obj). Then, the system control returns to Step S102 and the processes are repeated.

Meanwhile, if it is determined that the selection is not awaited (No at Step S103), then the first detecting unit 113 determines whether the mode is the already-selected mode (mode=1), that is, whether or not the detection of a relationship command is awaited (Step S107). If the mode is the already-selected mode (Yes at Step S107), then the first detecting unit 113 determines whether or not a relationship command (such as a lead line) is detected (Step S108). Herein, a lead line is only an example of the relationship command, and another object such as an arrow may also be a relationship command.

If no relationship command is detected (No at Step S108), then the system control returns to Step S102 and the processes are repeated. On the other hand, if a relationship command is detected (Yes at Step S108); then the first detecting unit 113 sets the detected relationship command (such as a lead line) in arc (Step S109). Moreover, the first detecting unit 113 updates the mode to an additional-stroke detection wait mode (mode=2). Furthermore, the first detecting unit 113 initializes the list ST of additional strokes and the list SL of strokes (ST=SL=null). At that time, the display control unit 111 may display a writing frame W so as to enable writing of an additional stroke. Then, the system control returns to Step S102 and the processes are repeated.

Meanwhile, if it is determined that the mode is not the already-selected mode (No at Step S107), then the first detecting unit 113 determines whether or not writing has completed (Step S110). Herein, the processes performed at Step S110 and Step S111 are respectively identical to the processes performed at Step S6 and Step S7 illustrated in FIG. 9.

When writing has completed (Yes at Step S110), the first detecting unit 113 recognizes the additional stroke ((obj2, cmd)=recog(ST)) (Step S112). At that time, the configuration may be such that the display control unit 111 erases the display of the writing frame W and, as an indication of completion of writing, erases the display of the stroke S that is written in the area other than the writing frame W.

The subsequent processes performed from Step S113 to Step S116 are respectively identical to the processes performed at Step S9 to Step S12 illustrated in FIG. 9.

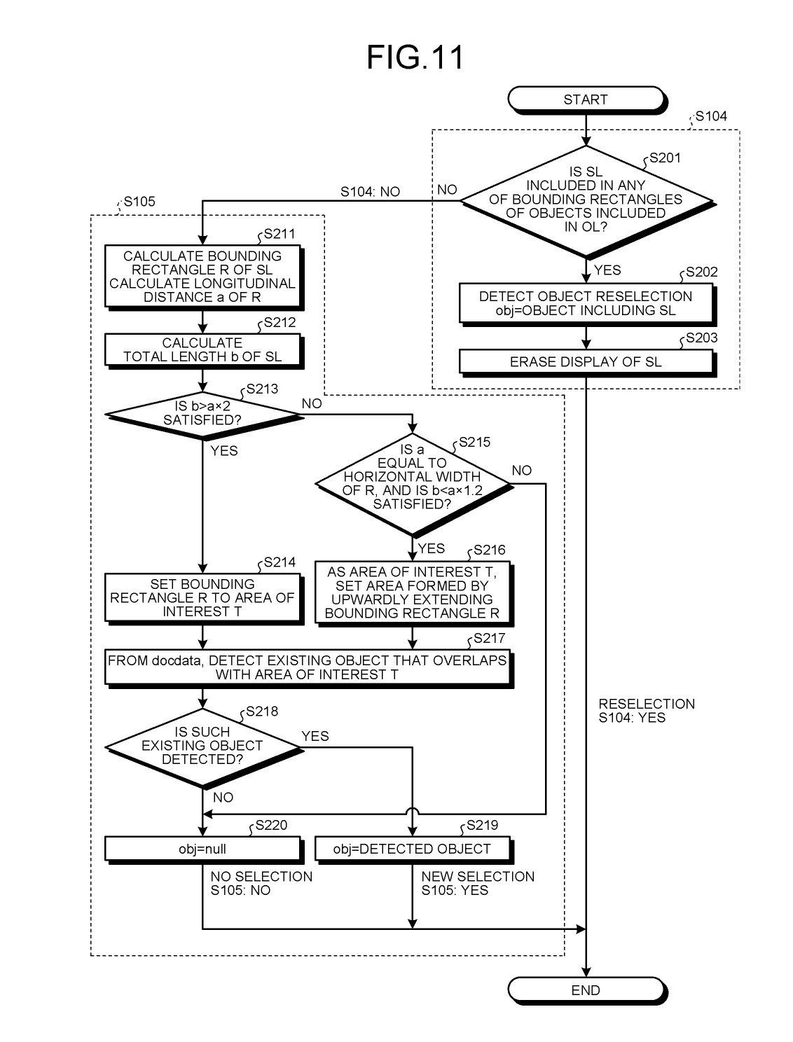

Given below is the explanation of further details of the process of detecting the selection of an object (Step S104 and Step S105) that was explained with reference to FIG. 10. FIG. 11 is a flowchart for explaining an example of the object selection detecting process.

The first detecting unit 113 determines whether or not the list SL of the strokes S is included in any of the bounding rectangles of the objects included in the list OL of existing objects (Step S201). If the list SL of the strokes S is included in any of the bounding rectangles of the objects (Yes at Step S201), then the first detecting unit 113 detects that an object has been reselected (Step S202). In this case, the first detecting unit 113 sets, in obj, an object that includes the strokes S listed in the list SL. Then, the display control unit 111 erases the display of the strokes S listed in the list SL (Step S203). As a result, the object that the user wishes to reselect can be reselected just by tapping on that object.

On the other hand, if the list SL is not included in the bounding rectangles of any of the objects included in the list OL of existing objects (No at Step S201), then the first detecting unit 113 attempts to detect an enclosing line or an underline. That detection can be performed by implementing the method explained with reference to FIGS. 5 to 7. Alternatively, herein, the explanation is given for performing detection by implementing a simpler method. The first detecting unit 113 calculates a bounding rectangle R of the stroke S included in the list SL, as well as calculates a longitudinal distance “a” of the bounding rectangle R (Step S211). Then, the first detecting unit 113 calculates a total length “b” of the stroke S included in the list SL (Step S212).

Subsequently, the first detecting unit 113 determines whether or not the total length b is greater than twice the longitudinal distance a (i.e., whether or not b>a×2 is satisfied) (Step S213). If the total length b is greater than twice the longitudinal distance a (Yes at Step S213), then the first detecting unit 113 sets the bounding rectangle R to an area of interest T (Step S214). On the other hand, if the longitudinal distance a is equal to horizontal width of the bounding rectangle R, and the total length b is equal to or smaller than twice the longitudinal distance a (No at Step S213 and Yes at Step S215), then the first detecting unit 113 sets the area formed by upwardly expanding the bounding rectangle R as the area of interest T (Step S216). Otherwise (No at Step S215), the second detecting unit 114 sets null in obj1 as an indication that no object was selected (Step S220). That marks the end of the processes.

Regarding the case in which the total length b is greater than twice the longitudinal length a, it can be assumed that encircling is done. Similarly, regarding the case in which the total length b is greater than 1.2 times of the longitudinal length a, it can be assumed that underlining is done. If encircling and underlining can be differentiated, then the total length b can be compared with a value other than twice or 1.2 times of the longitudinal length a.

The second detecting unit 114 detects, from the document data (docdata), such an existing object for which the degree of overlapping with the area of interest T (for example, the ratio of the dimension of the overlapping area) is equal to or greater than a predetermined threshold value (Step S217). The ratio between the area of interest T and the dimension of the overlapping area can be obtained as, for example, the proportion of the dimension of the overlapping area between the area of interest T and the existing object with respect to the dimension of the entire existing object.

The second detecting unit 114 determines whether or not such an existing object is detected (Step S218). If such an existing object is detected (Yes at Step S218), then the second detecting unit 114 sets the detected object in obj (Step S219). On the other hand, if no such existing object is detected (No at Step S218), then the second detecting unit 114 sets obj to null (Step S220). That marks the end of the processes.

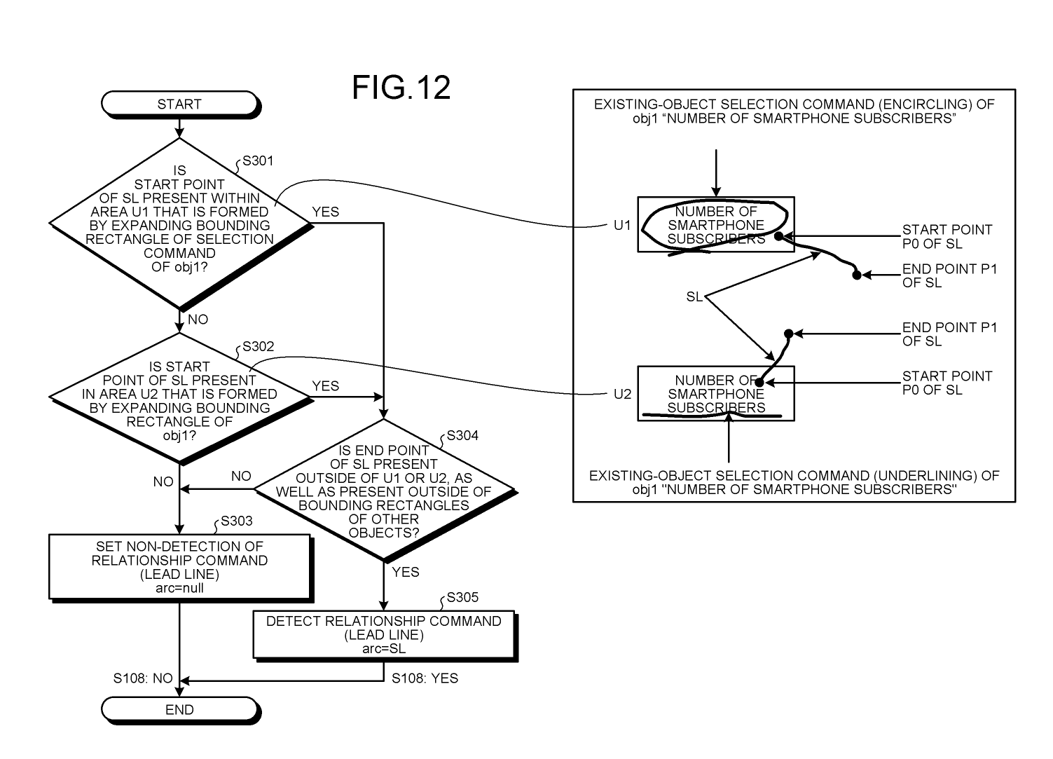

Given below is the explanation of further details of the relationship command detecting process performed at Step S108 illustrated in FIG. 10. FIG. 12 is a flowchart for explaining an example of the relationship command detecting process. Meanwhile, on the right-hand side of the flowchart illustrated in FIG. 12, a plurality of specific examples of data is given. Of those examples, the example on the upper side is about a case when the selection command indicates encircling, while the example on the lower side is about a case when the selection command indicates underlining. At the time of starting the processes illustrated in the flowchart in FIG. 12, the list obj1 of already-selected and existing objects has at least a single existing object registered therein. The following processes are performed with respect to each object registered in the list obj1.

The first detecting unit 113 determines whether or not the start point of a stroke included in the list SL is present within an area U1 that is formed by expanding the bounding rectangle of the selection command of each object included in the list obj1 by a predetermined length in the leftward direction, the rightward direction, the upward direction, and the downward direction (Step S301). In the example of encircling illustrated in FIG. 12, it is determined that a start point P0 of a stroke is present within the area U1.

If, regarding any of the objects, the start point of a stroke is not present within the area U1 (No at Step S301); then the first detecting unit 113 determines whether or not the start point of the stroke included in the list SL is present within an area U2 that is formed by expanding the bounding rectangle of each object included in the list obj1 by a predetermined length in the leftward direction, the rightward direction, the upward direction, and the downward direction (Step S302). In the example of underlining illustrated in FIG. 12, it is determined that the start point P0 of the stroke is present within the area U2.

If the start point of the stroke is not present within the area U2 (No at Step S302), then the first detecting unit 113 performs setting (arc=null) to indicate that no relationship command (such as a lead line) is detected (Step S303). That marks the end of the processes.

Meanwhile, if the start point of a stroke is present within the area U1 (Yes at Step S301) or if the start point of a stroke is present within the area U2 (Yes at Step S302), then the first detecting unit 113 determines whether or not the end point of the stroke included in the list SL is present not only on the outside of the area U1 or the area U2 but also on the outside of the bounding rectangles of the other objects (Step S304). In the examples illustrated in FIG. 12, it is determined that an end point P1 of the stroke is present on the outside of the area U1 and the area U2.

If the end point of the stroke is present not only on the outside of the area U1 or the area U2 but also on the outside of the bounding rectangles of the other objects (Yes at Step S304), then the first detecting unit 113 detects the stroke included in the list SL as a relationship command (such as a lead line) (arc=SL) (Step S305).

On the other hand, if the end point of the stroke is not present on the outside of the area U1 or the U2 or if the end point of the stroke is not present on the outside of the bounding rectangles of the other objects (No at Step S304), then the first detecting unit 113 performs setting (arc=null) to indicate non-detection of a relationship command (such as a lead line) (Step S303). That marks the end of the processes.

With reference to FIG. 10, when one object (a single object) is selected (Yes at Step S104 or Yes at Step S105), then the system control proceeds to the relationship command detecting process (Step S108 onward). Alternatively, the configuration may be such that a plurality of objects can be selected.

FIG. 13 is a flowchart for explaining an example of the stroke-analyzing and responding process in the case when the selection of a plurality of objects is allowed. As compared to FIG. 10, the processes performed at Step S103-2, Step S105-2 and Step S107-2 are different than the processes performed at Step S103, Step S105 and Step S107, respectively, illustrated in FIG. 10. Other than that, the processes illustrated in FIG. 13 are identical to the processes illustrated in FIG. 10. The identical processes are referred to by the same step numbers, and the explanation thereof is not repeated.

As compared to the process performed at Step S103 illustrated in FIG. 10, the process performed at Step S103-2 differs in the following way: not only in the case of mode=0 but also in the case of mode=1, the mode is determined to be the selection wait mode; and if it is determined that the mode is not the selection wait mode (No at Step S103-2), then the system control proceeds to Step S110.

As compared to the process performed at Step S105 illustrated in FIG. 10, the process performed at Step S105-2 differs in the following way: if an object is not newly selected (No at Step S105-2), then the system control proceeds to Step S107-2.

As compared to the process performed at Step S107 illustrated in FIG. 10, the process performed at Step S107-2 differs in the following way: if it is determined that the mode is not the already-selected mode (mode=1) (No at Step S107-2), then the system control returns to Step S102.

As a result of performing these processes, it becomes possible to select a plurality of objects until a relationship command is detected, that is, until the mode is updated to mode=2 at Step S109.

Given below is the explanation of a specific example of information processing performed according to the embodiment.

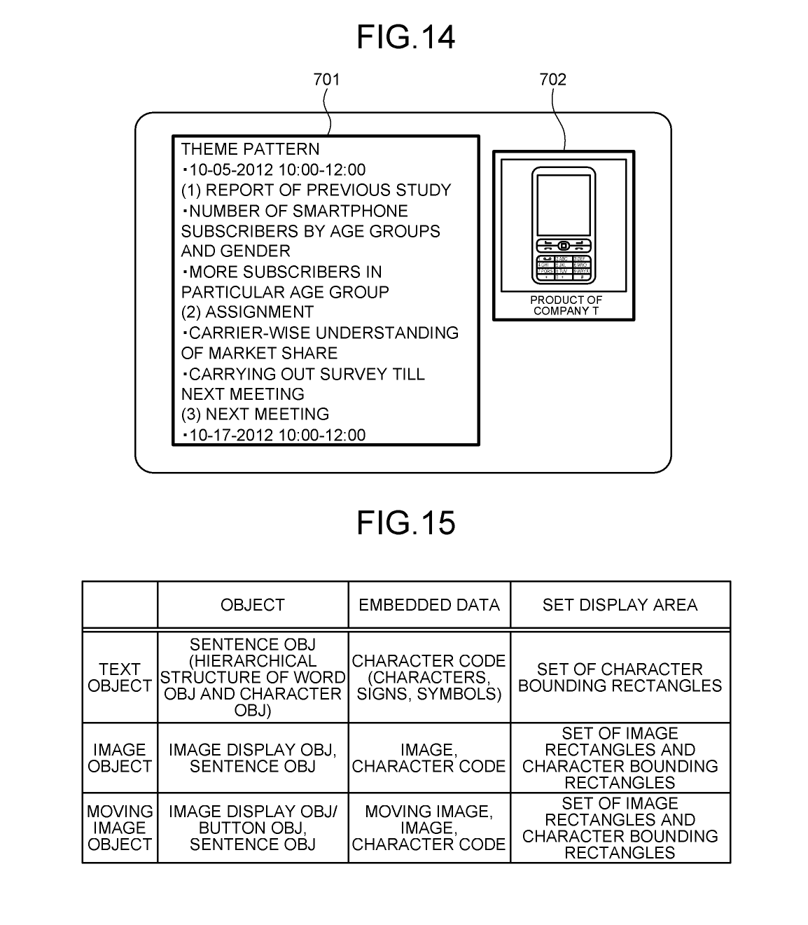

FIG. 14 is a diagram illustrating an example of the document data that is displayed. In FIG. 14 is illustrated an example in which the document data contains a text object 701 and an image object 702.

FIG. 15 is a diagram illustrating an example of the data structure of objects included in the document data. As illustrated in FIG. 15, the document data can contain text objects, image objects, and moving image objects. The types of objects are not limited to the abovementioned types. That is, for example, the document data may also contain objects including handwritten documents or contain audio objects.

A text object (sentence OBJ) may include, for example, word objects (word OBJ) and character objects (character OBJ) in a hierarchical structure. In a text object are embedded character codes representing characters, signs, and symbols. Regarding a text object, a set of rectangles circumscribing the characters (i.e., a set of character bounding rectangles) is set as the display area.

An image object may include, for example, objects for displaying images (image display OBJ) and the above-mentioned sentence OBJ such as captions or the like. In an image object are embedded images and character codes. Regarding an image object, a set of rectangles displaying images (image rectangles) and the abovementioned character bounding rectangles is set as the display area.

A moving image object may include, for example, an image display OBJ, a button object for starting the replay (button OBJ), and the abovementioned sentence OBJ such as captions or the like. In a moving image object are embedded moving images, images, and character codes. Regarding a moving image object, a set of image rectangles and character bounding rectangles is set as the display area.

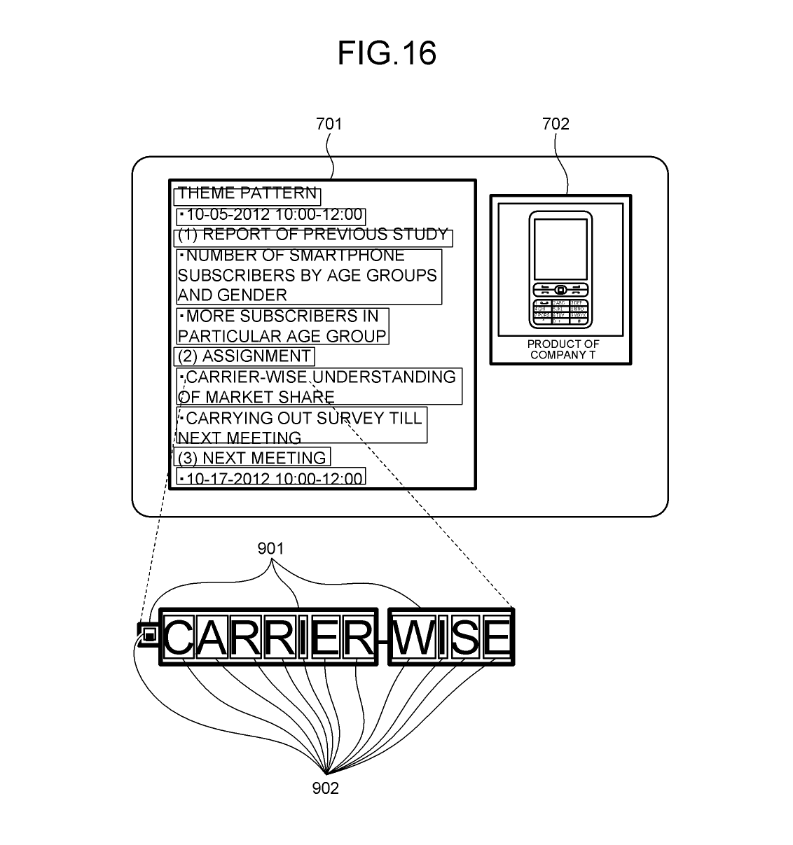

FIG. 16 is a diagram for explaining an example of the hierarchical structure of objects.

The text object 701 can include, in the first hierarchy, sentence OBJ enclosed in inner rectangles. Meanwhile, herein the rectangles are illustrated for the sake of convenience and need not be displayed on the display unit 121. The text object 701 illustrated in FIG. 16 contains 10 character OBJ.

Each sentence OBJ includes word OBJ in a lower hierarchy (the second hierarchy). In FIG. 16, each rectangle 901 illustrated in the lower portion corresponds to a word OBJ. With reference to FIG. 16, in the portion “ EACH CARRIER”; three word OBJ, namely, “”, “EACH”, and “CARRIER” are included. Herein, the word OBJ may be obtained by means of, for example, morphological analysis.

Each word OBJ further includes characters OBJ in a lower hierarchy (the third hierarchy). In FIG. 16, each rectangle 902 corresponds to a character OBJ. Herein, for example, each character OBJ includes display area data and character code data. The display area data indicates the area in which the corresponding character OBJ is displayed.

The image object 702 can include, in the first hierarchy, image display OBJ and sentence OBJ enclosed in inner rectangles. In FIG. 16, an image of a cellular phone corresponds to an image display OBJ. Moreover, “PRODUCT OF COMPANY T” that is displayed below the image of the cellular phone corresponds to a sentence OBJ. The hierarchy structure of this sentence OBJ is identical to the hierarchy structure of the sentence OBJ explained with reference to the text object 701. Meanwhile, the image display OBJ includes, for example, display area data and image data.

The data structure illustrated in FIG. 16 is, for example, set in advance; and may be input as part of the document data at the time of inputting the document data. Alternatively, the configuration may be such that an image that captures document data is recognized and analyzed (subjected to morphological analysis), and data having the structure as illustrated in FIG. 16 is generated. Meanwhile, the data structure illustrated in FIG. 16 is only exemplary, and is not the only possible data structure. Alternatively, for example, the caption appended to the image of the image object 702 (in the example illustrated in FIG. 16, “PRODUCT OF COMPANY T”) may be a text object. Moreover, in the case of an object including a handwritten document, the stroke data may be included in place of the character code data.

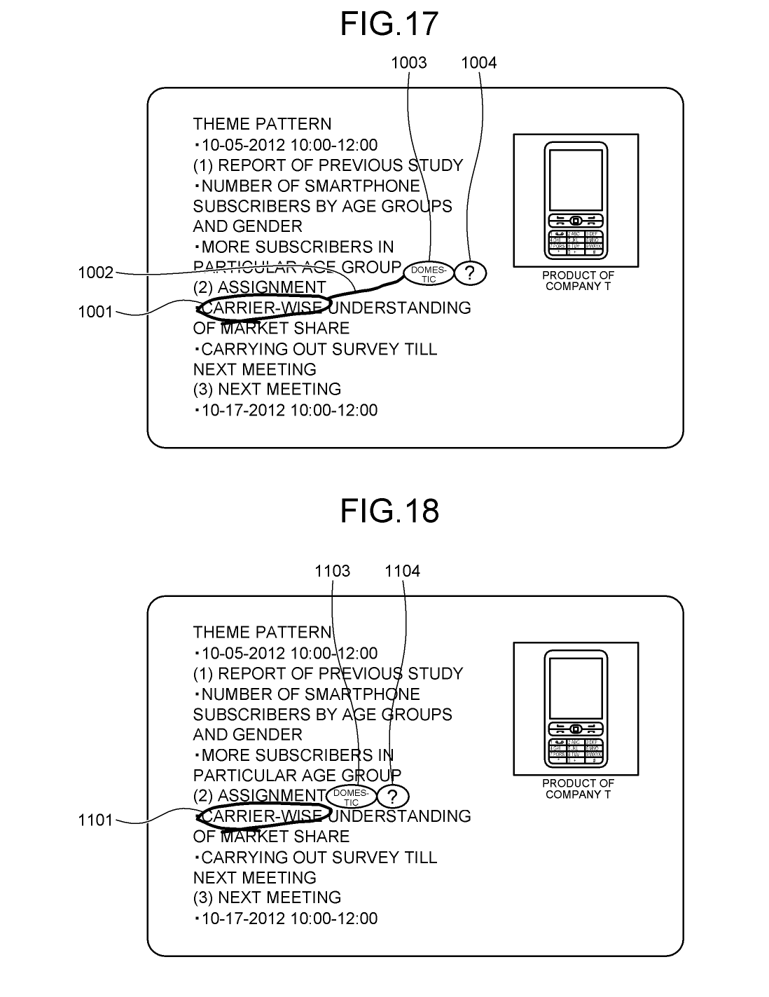

FIG. 17 is a diagram illustrating an exemplary sequence of processes performed during the search process. In FIG. 17 is illustrated an example in which an existing-object selection command 1001 (encircling or underlining), a relationship command 1002 (writing a lead line or an arrow), an additional object 1003 (writing an arbitrary character string), and a search command 1004 (writing “?” or the like) are written in that particular order. With reference to FIG. 9, the selection command 1001 and the relationship command 1002 are respectively detected at Step S4 and Step S5, while the additional object 1003 and the search command 1004 are detected at Step S8. In the example illustrated in FIG. 17, the executing unit 115 performs a search process using the existing object “CARRIER”, which is selected in response to the selection command 1001, and using the additional object 1003 (=“DOMESTIC”). For example, the executing unit 115 performs a search in which only an object (only an existing object or only an additional object) is treated as the search query as well as performs a search in which the AND condition of objects is treated as the search query (i.e., performs an AND search). However, the method of performing the search process is not limited to this method. Alternatively, for example, the executing unit 115 may perform only the AND search of objects.

Meanwhile, it is possible to omit the input of a relationship command illustrated in FIG. 17. FIG. 18 is a diagram illustrating an exemplary sequence of processes performed during the search process when the input of a relationship command is omitted. In FIG. 18 is illustrated an example in which an existing-object selection command 1101, an additional object 1103, and a search command 1104 are written in that particular order. In this case too, the executing unit 115 performs a search process using the existing object “CARRIER”, which is selected in response to the selection command 1101, and using the additional object 1103 (=“DOMESTIC”).

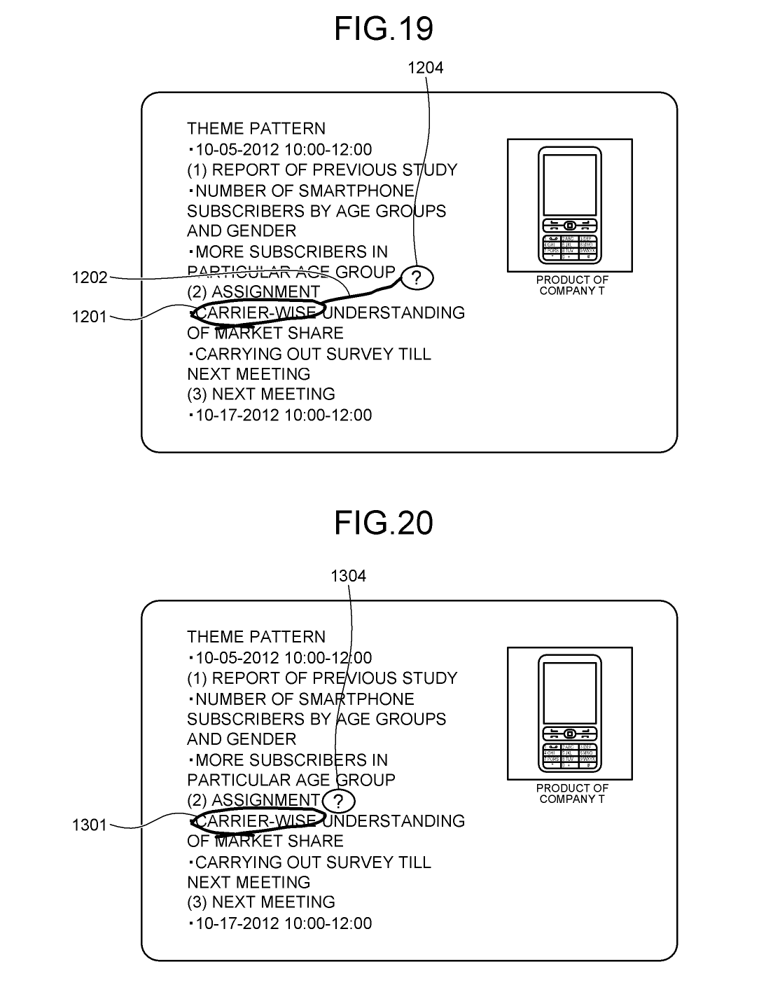

Meanwhile, it is also possible to omit the input of an additional object. FIG. 19 is a diagram illustrating an exemplary sequence of processes performed during the search process when the input of an additional object is omitted. In FIG. 19 is illustrated an example in which an existing-object selection command 1201, a relationship command 1202, and a search command 1204 are written in that particular order. In this case, the executing unit 115 performs a search process using the existing object “CARRIER” that is selected in response to the selection command 1201.

Moreover, the input of a relationship command may also be omitted from FIG. 19. FIG. 20 is a diagram illustrating an exemplary sequence of processes performed during the search process when the input of a relationship command is also omitted. In FIG. 20 is illustrated an example in which an existing-object selection command 1301 and a search command 1304 are written in that particular order. In this case, the executing unit 115 performs a search process using the existing object “CARRIER” that is selected in response to the selection command 1301.

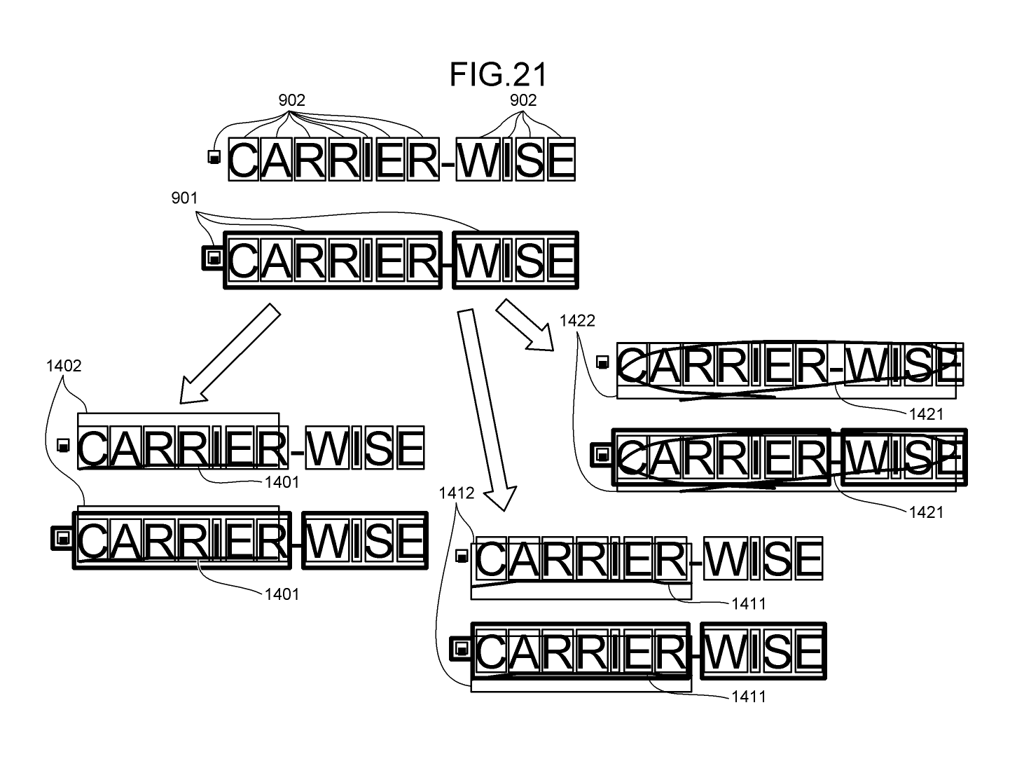

Given below is the explanation of an example of writing performed to select an existing object (i.e., an example of writing a selection command) and an example of the existing object that is selected. FIG. 21 is a diagram illustrating an example of the relationship between the selection command, the area of interest, and the selected object.

The rectangles 902 correspond to the display areas of character OBJ. The rectangles 901 correspond to the display areas of word OBJ. In the lower part of FIG. 21 are illustrated examples of object selection in response to the input of three different selection commands issued with respect to such a text object.

In the case of an underline 1401 that is written in an overlapping manner with respect to the character string “CARRIER”, the triangle formed by extending the bounding rectangle of the underline 1401 in the upward direction by a predetermined amount becomes an area of interest 1402. In this case, as the existing object, the word “CARRIER” is selected that has the interference dimension ratio with the area of interest 1402 equal to or greater than a threshold value. Herein, the interference dimension is, for example, the dimension of the overlapping area between an area of interest 1042 and the existing object.

In the case of an underline 1411 that is written in a correct manner (without overlapping) below the character string “CARRIER”, the triangle formed by extending the bounding rectangle of the underline 1411 in the upward direction by a predetermined amount becomes an area of interest 1412. In this case, as the existing object, the word “CARRIER” is selected that has the interference dimension ratio with the area of interest 1402 equal to or greater than a threshold value.

In the case of an encircling line 1421 that is written to encircle the character string “CARRIER”, the bounding rectangle of the encircling line 1421 becomes an area of interest 1422. In this case, as the existing object, the words “EACH CARRIER” are selected that have the interference dimension ratio with the area of interest 1422 equal to or greater than a threshold value.

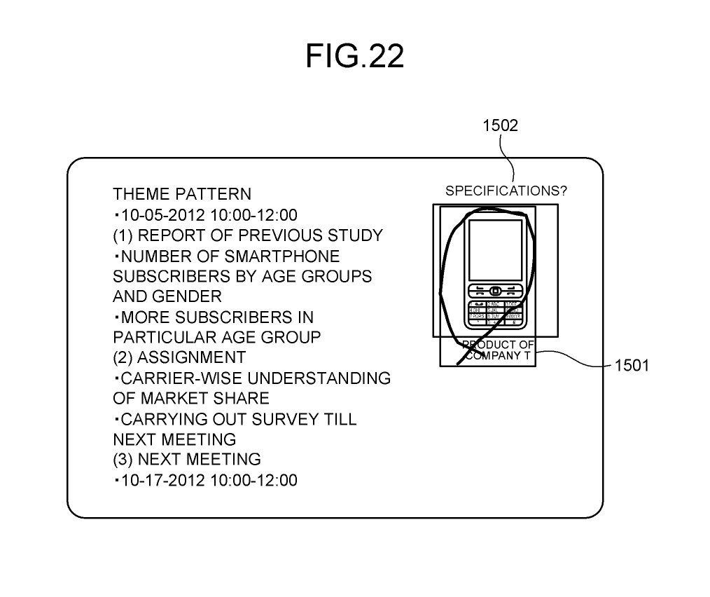

FIG. 22 is a diagram illustrating an example in which a search is performed with an image object treated as the search query. In the case when a selection command is in the form of an encircling line as illustrated in FIG. 22, the bounding rectangle of the encircling line becomes an area of interest 1501. The image of a cellular phone and the character string “PRODUCT OF COMPANY T” are included in the area of interest 1501. If it is assumed that an additional object 1502 (“SPECIFICATIONS”) is input, then searches are performed in which objects are treated as search queries as well as AND searches of objects are performed in the following manner.

(1) a similar image search in which the image of the cellular phone is treated as the search query
(2) an information search in which the existing object “PRODUCT OF COMPANY T” is treated as the search query
(3) an information search in which the additional object “SPECIFICATIONS” is treated as the search query
(4) an AND search of (1) and (2)
(5) an AND search of (1) and (3)
(6) an AND search of (2) and (3)
(7) an AND search of (1), (2), and (3)

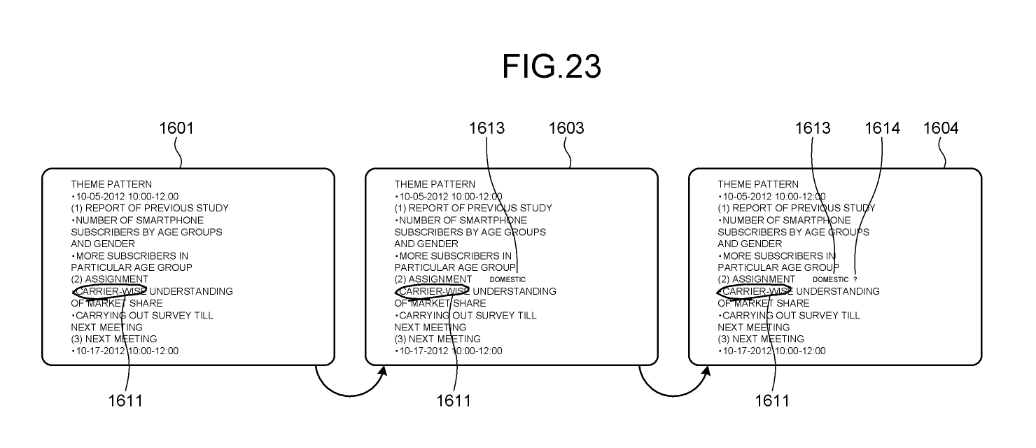

FIG. 23 is a diagram illustrating an example of the sequence followed during the search process. Herein, screens 1601, 1603, and 1604 are examples of screens in which a selection command 1611, an object 1613, and an object 1614 are respectively input in that particular order. In the explanation given till now, the time interval for handwritten input was not taken into consideration. However, the configuration may also be such that each command is detected by taking into account the time interval.

For example, in the case when the difference between the detection timing of the selection command 1611 and the detection timing of the object 1613 is within a predetermined period of time, then the first detecting unit 113 may detect the object 1613 as the additional object. Meanwhile, the order of detection (selection) of objects is arbitrary. For example, even in the case when the object 1613 is detected earlier and the selection command 1611 is detected later; as long as the difference between the detection timings thereof is within a predetermined period of time, the object 1613 may be selected as the additional object.

On the other hand, if the difference between the detection timings is greater than the predetermined period of time, then the first detecting unit 113 may determine that the object 1613 is an annotation. Moreover, for example, if the difference between the detection timing of the additional object (the object 1613) and the detection timing of the object 1614 is within a predetermined a predetermined period of time, then the first detecting unit 113 may detect the object 1614 as a search command.

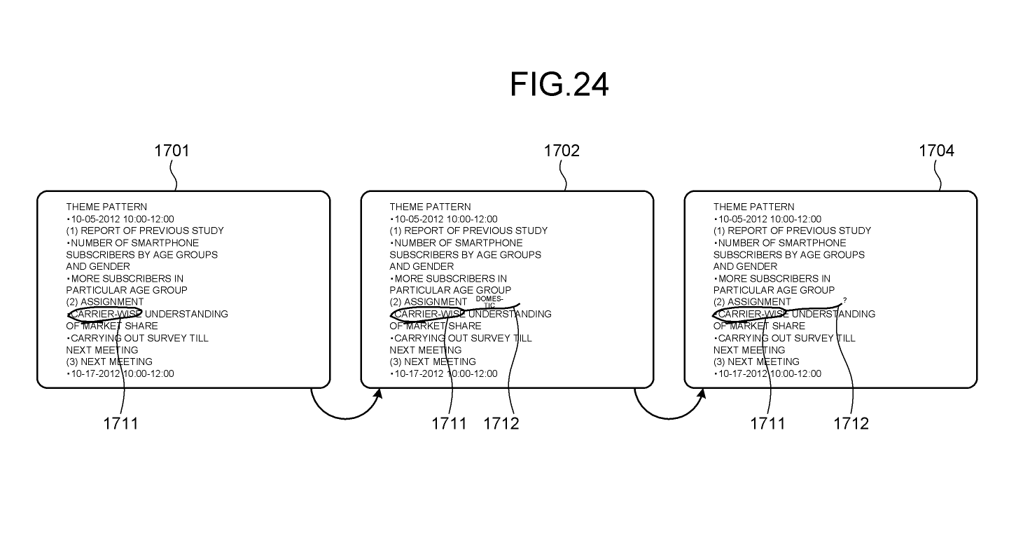

FIG. 24 is a diagram illustrating another example of the sequence followed during the search process. Herein, screens 1701, 1702, and 1704 are examples of screens in which a selection command 1711, an object 1712, and an object 1714 are respectively input in that particular order. If the difference between the detection timing of the selection command 1711 and the detection timing of the object 1712 is within a predetermined period of time, then the first detecting unit 113 may detect the object 1712 as a relationship command. In a similar manner, if the difference between the detection timing of the object 1712 (the relationship command) and the detection timing of the object 1714 is within a predetermined period of time, then the first detecting unit 113 may detect the object 1714 as a search command.

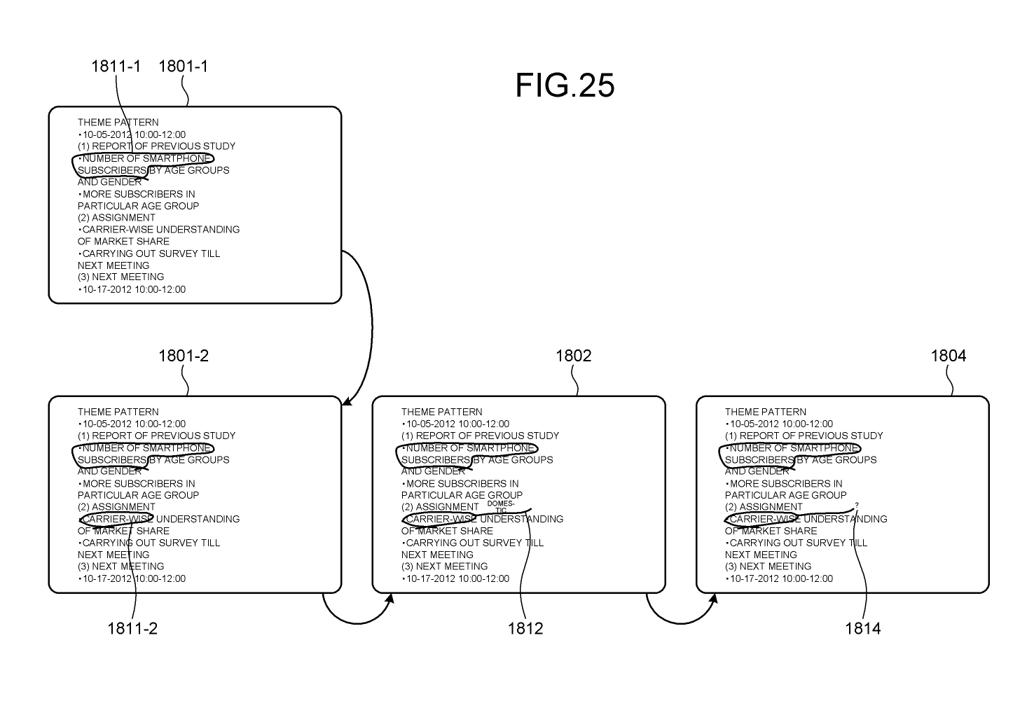

FIG. 25 is a diagram illustrating still another example of the sequence followed during the search process. In FIG. 25 is illustrated a case in which a plurality of existing objects may be selected. Herein, screens 1801-1, 1801-2, 1802, and 1804 are examples of screens in which a selection command 1811-1, a selection command 1811-2, an object 1812, and an object 1814 are respectively input in that particular order. If the difference between the detection timing of the selection command 1811-1 and the detection timing of the selection command 1811-2 is within a predetermined period of time, then the first detecting unit 113 may add the objects selected in response to those selection commands in the list (obj1) of existing objects.

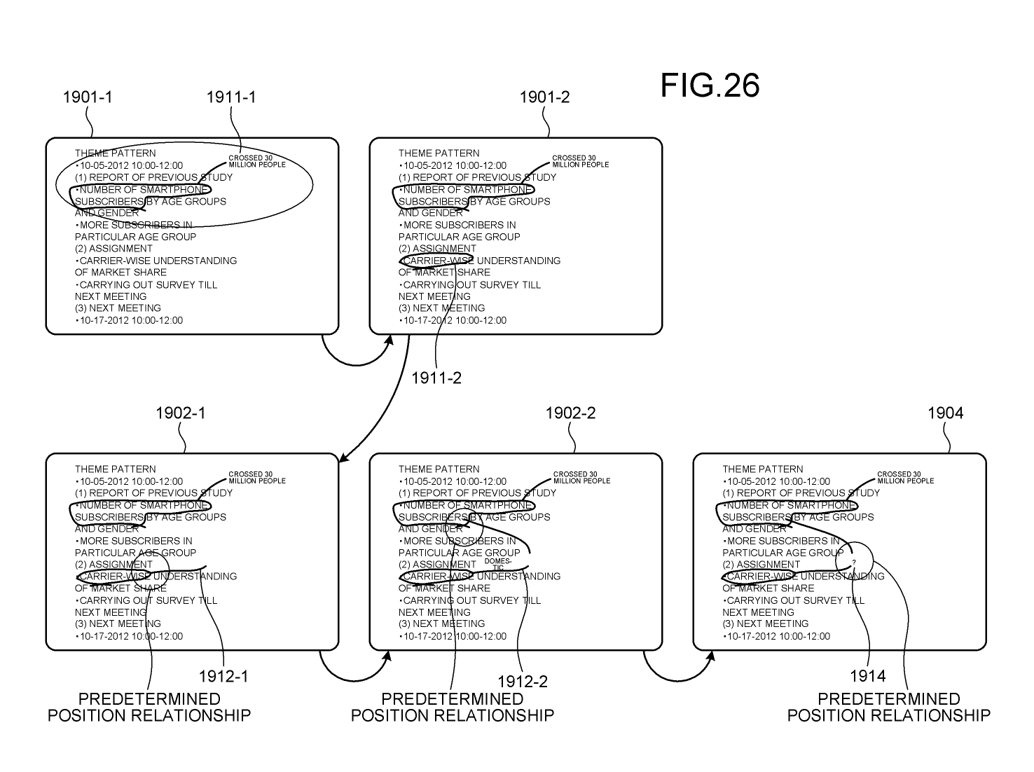

FIG. 26 is a diagram illustrating still another example of the sequence followed during the search process. In FIG. 26 is illustrated a case in which a selection command and an annotation that are written beforehand are associated afresh and are treated as a search query after the elapse of a predetermined period of time. Herein, screens 1901-1, 1901-2, 1902-1, 1902-2, and 1904 are examples of screens in which prior writing 1911-1 containing a selection command and an annotation, prior writing 1911-2 containing a selection command, an object 1912-1, an object 1912-2, and an object 1914 are respectively input in that particular order. The prior writing 1911-1 as well as the prior writing 1911-2 is assumed to be written prior to the input of the object 1912-1.

In such a case too, if the relationship commands (the object 1912-1 and the object 1912-2) are written so as to ensure predetermined position relationships, the objects corresponding to the prior writing 1911-1 and the prior writing 1911-2 may be included in a search query. For example, in the case when conditions (1) to (5) given below are satisfied; the existing object (“number of smartphone subscribers”) and the annotation (“crossed 30 million people”) that are selected in response to the selection command included in the prior writing 1911-1 as well as the existing object (“CARRIER”) that is selected in response to the selection command included in the prior writing 1911-2 may be included in a search query.

(1) the object 1912-1 has a predetermined position relationship with the prior writing 1911-2
(2) the object 1912-2 has a predetermined position relationship with the selection command included in the prior writing 1911-2
(3) the object 1914 has predetermined position relationships with the object 1912-1 and the object 1912-2
(4) the difference between the input timing of the object 1912-1 and the input timing of the object 1912-2 is within a predetermined period of time
(5) the difference between the input timing of the object 1912-2 and the input timing of the object 1914 is within a predetermined period of time

Herein, a predetermined position relationship indicates a relationship in which an extreme point (the start point or the end point) of a stroke is present inside the bounding rectangle (or inside the area formed by expanding the bounding rectangle by a predetermined length) of a selection command.

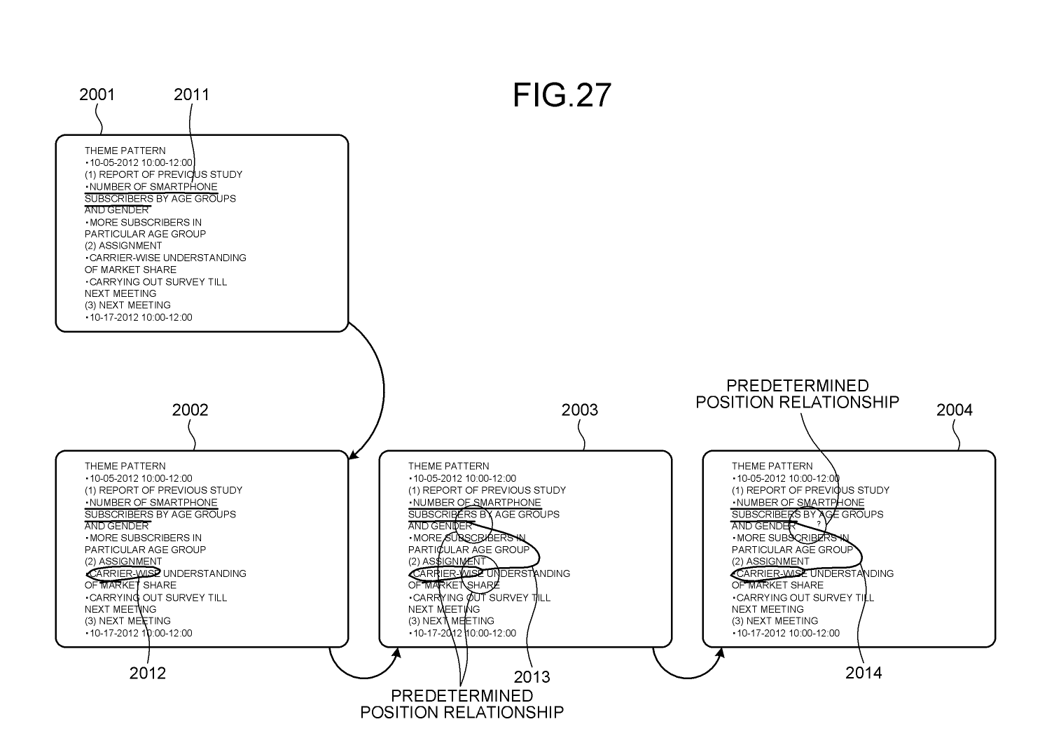

FIG. 27 is a diagram illustrating still another example of the sequence followed during the search process. In FIG. 27 is illustrated an example of performing a search using a relationship command that is written by a different method as compared to FIG. 26. Herein, screens 2001, 2002, 2003, and 2004 are examples of screens in which a selection command 2011, a selection command 2012, an object 2013, and an object 2014 are respectively input in that particular order. In the example illustrated in FIG. 27, the object 2013 serving as a relationship command joins a plurality of selection commands (the selection command 2011 and the selection command 2012). In such a case too, if the commands satisfy predetermined position relationships, it becomes possible to perform a search process in which a plurality of existing objects corresponding to a plurality of selection commands can be treated as search queries.

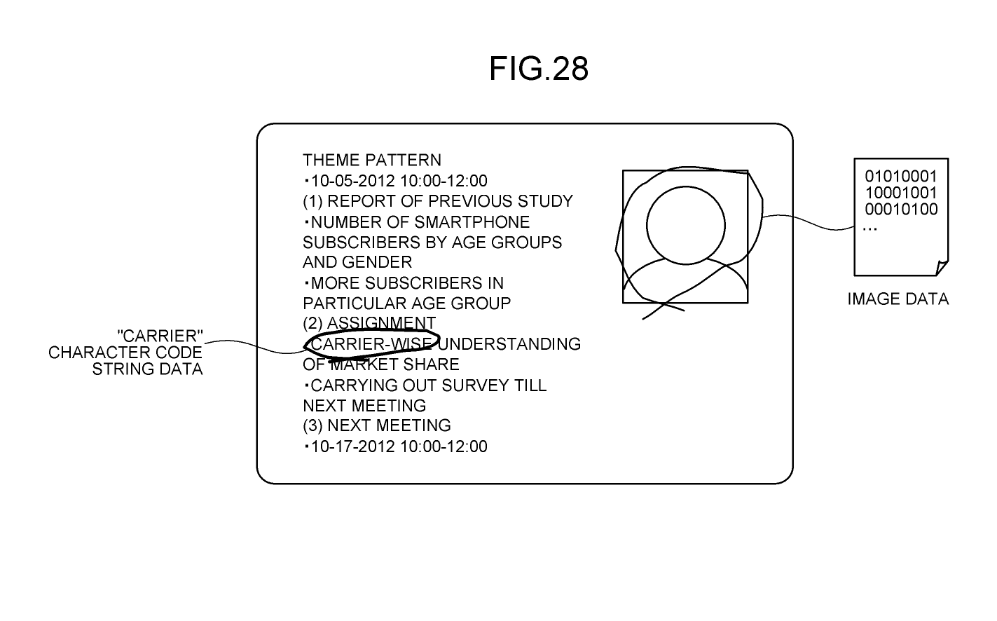

FIG. 28 is a diagram illustrating an example of the data (search query data) used in a search process. As illustrated in FIG. 28, data containing character codes (character code string data (“CARRIER”)) and image data can be treated as the search query data. In the case of using character code string data, a sentence matching with or similar to the character code string data is retrieved. In the case of using image data, an image matching with or similar to the image data is retrieved. The similar image search may be performed by implementing any of the conventional methods such as the method of comparing feature quantities obtained from the image data.

Meanwhile, during the processes as well as after performing the processes, the executing unit 115 can change the display mode of the objects so as to enable the user to recognize that the processes are underway or that the processes have been performed. For example, during a search process, the display control unit 111 can display an animation in which the display of at least one of the selection command, the relationship command, and the search command changes. Alternatively, the display control unit 111 may change at least one of the following display modes of each command: color, brightness (blinking), stroke width, size, shape (such as rippling), and position (such as swingy).

Moreover, after the search process is completed, the display control unit 111 may erase, for example, the relationship command and the search command from the display unit 121. As a result, it becomes possible to erase unnecessary command stroke data from the display, and to ensure that there is no loss in readability of the document data that is being displayed in the background.

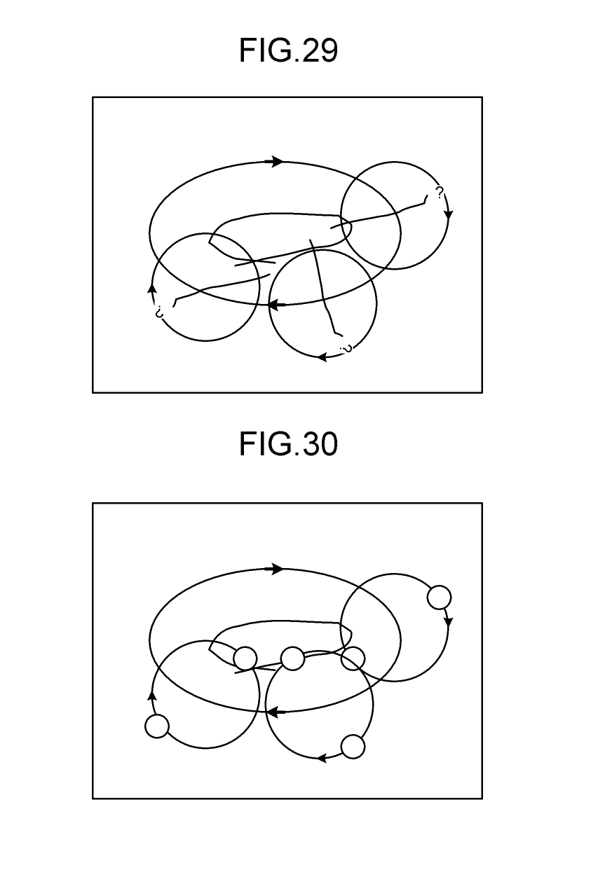

FIGS. 29 and 30 are diagrams illustrating examples of animation display. In FIG. 29 is illustrated an exemplary animation in which the relationship command and the search command rotate while revolving in an elliptical orbit around the selection command. Herein, when the search is over, the display control unit 111 can end the animation display and then display the relationship command and the search command at the respective original positions.

In FIG. 30 is illustrated an exemplary animation in which the relationship command and the search command illustrated in FIG. 29 are changed to two balls (flickering or otherwise) and are moved in an identical manner to that illustrated in FIG. 29. Herein, when the search is over, the display control unit 111 can perform display in which the two balls go on becoming smaller and darker and eventually disappear.

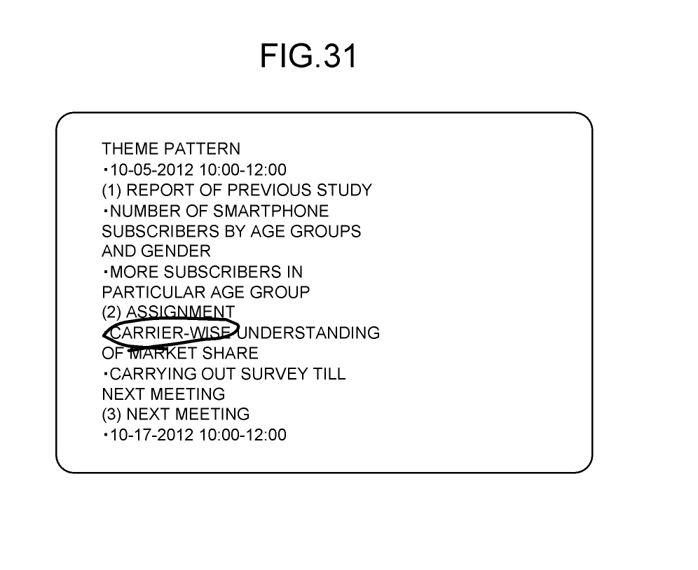

FIG. 31 is a diagram illustrating an example of the screen from which unnecessary commands are erased. In addition, when the search is over, the display control unit 111 can change the display mode of the selection command. For example, when the search is over, the display control unit 111 can change the color, the stroke width (such as thickening), and the shape (such as changing to an ellipse) of the selection command. Alternatively, the display control unit 111 may further erase the selection command.

As described till now, in the embodiment, processes such as a search process can be performed using not only existing objects that are detected from a displayed document but also additional objects that are additionally input in handwriting. As a result, processes according to the handwritten input can be performed in a more accurate manner. In the example illustrated in FIG. 17, the search process is performed using not only the existing object “CARRIER”, which is selected in response to the selection command 1001, but also the additional object 1003 (=“DOMESTIC”).

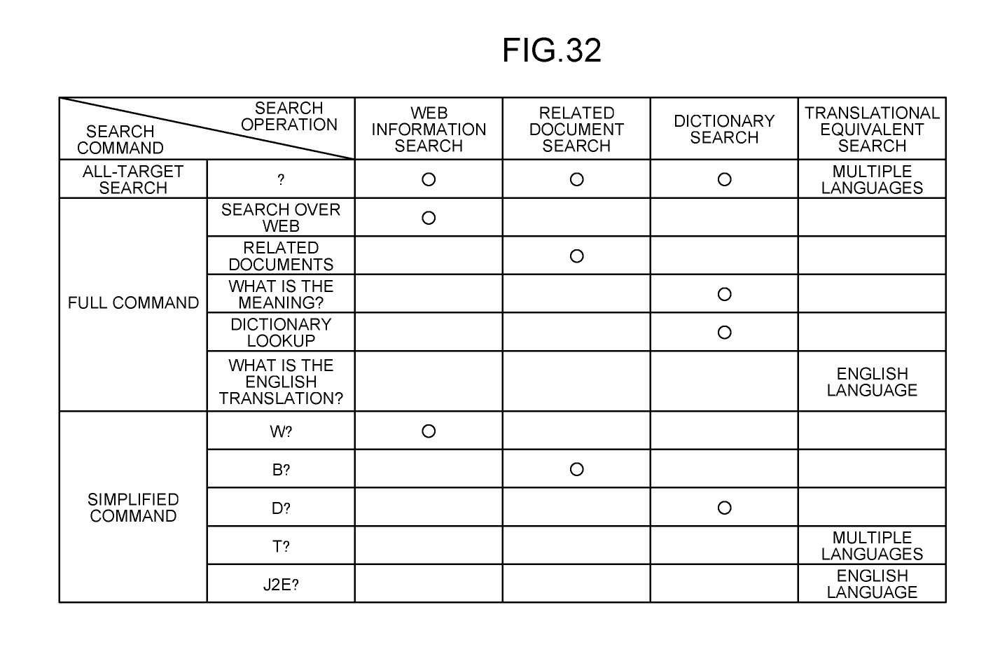

In addition, the configuration may be such that the document (or the set of documents) to be searched can be changed according to the type of the search command. FIG. 32 is a diagram illustrating an example of the relationships between the search commands and the types of search process (the types of document to be searched). In the example illustrated in FIG. 32, the search commands are classified into the all-target search, the full command, and the simplified command. The target search indicates a run command for performing the search process by considering all documents as the search target. The full command and the simplified command indicate run commands for performing the search process by considering some of the documents as the search target. The full command includes words which enable identification of the documents considered to be the target search. The simplified command is formed by simplifying the contents of the full command using signs or the like.

In FIG. 32 is illustrated an example in which the full command “search over WEB” has a simplified command “W?” corresponding thereto. Meanwhile, the character strings and signs that are detected as search commands are stored, for example, in the storage unit 123.

In FIG. 32, “WEB information search” represents a search command in which the data on the WEB (such as the WEB data 131) is the search target. Moreover, “related document search” represents a search command in which, for example, the related documents 134 are the search target. Furthermore, “dictionary search” represents a search command in which, for example, the semantic dictionary 132 is the search target. Moreover, “translational equivalent search” represents a search command in which, for example, the translational equivalent dictionary 133 is the search target.

In the example illustrated in FIG. 17, using a search query that includes the existing object “CARRIER”, which is selected in response to the selection command 1001, and includes the additional object 1003 (=“DOMESTIC”); the search command 1004 (“?”) that is equivalent to the all-target search is executed.

Meanwhile, in the embodiment, a character string such as “search over WEB” can be detected as the additional object 1003. In the case when such a character string is specified, the executing unit 115 can be configured to perform a search with the document specified in the additional object as the search target and using existing objects as the search query. Hence, even if the configuration is not done as illustrated in FIG. 32 in which the document considered to be the search target is changed according to the type of the search command, it still becomes possible to perform the process of limiting the search target.

Alternatively, the configuration may be such that, instead of changing the search target according to the type of the search command, the search process is performed with respect to some or all of the search target documents, and the search result is displayed with respect to each search target document.

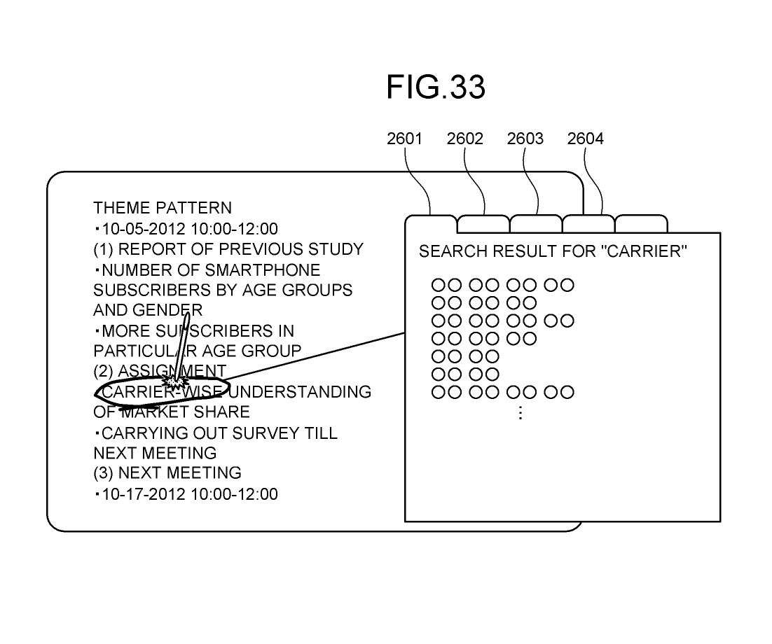

FIG. 33 is a diagram illustrating an example of outputting the search result. In FIG. 33 is illustrated an example of displaying the search result that is obtained when the existing object “CARRIER” is treated as the search query. Moreover, in FIG. 33 is illustrated an example in which a separate tab is made selectable for each search target document. For example, in tabs 2601 to 2604, the display control unit 111 may display the search result of search processes with respect to the WEB data, the related documents, the semantic dictionary, and the translational equivalent dictionary, respectively.

The display control unit 111 need not wait until the search result for all search targets is obtained. Instead, at the point of time of obtaining the search result of any one search target, the display control unit 111 may start displaying the search results. Moreover, until the search result of any one search target is obtained, the display control unit 111 may perform the process of changing the display mode of data in the manner described above.

Herein, regardless of an instruction from the user, the display control unit 111 may start displaying a search result at the point of time of obtaining that search result. Alternatively, the display control unit 111 may display a search result in response to the detection of a search result display instruction (such as a tap on the screen or on an object) from the user.

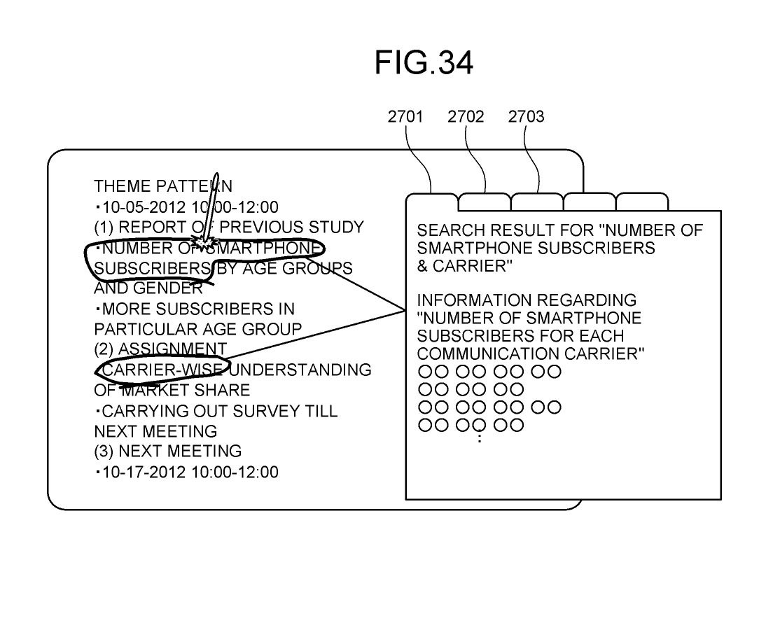

FIG. 34 is a diagram illustrating another example of outputting the search result. In FIG. 34 is illustrated an example of displaying the search result that is obtained when the existing object “CARRIER” and the existing object “NUMBER OF SMARTPHONE SUBSCRIBERS” are treated as the search query. For example, in tabs 2701 to 2703, the display control unit 111 may display the search result of the AND search of both objects and the search result of the search using each object.

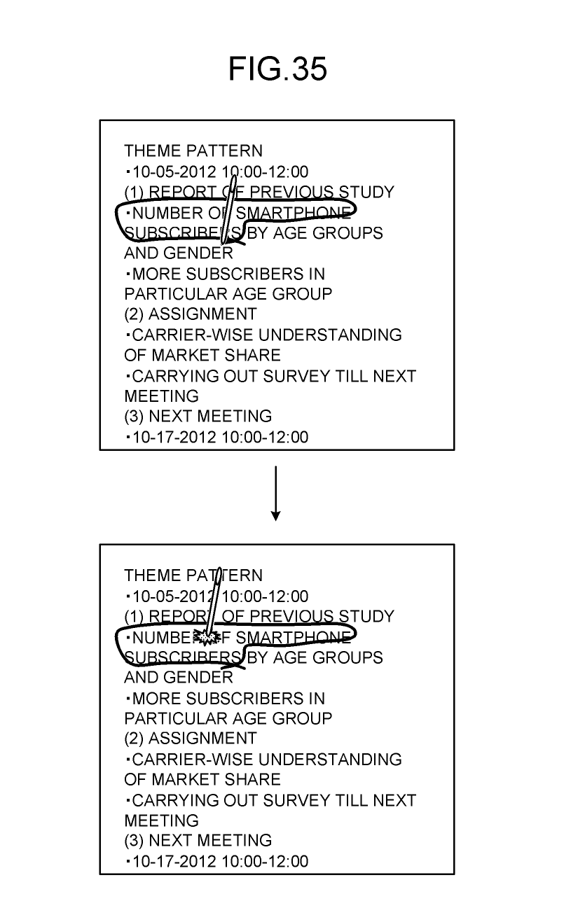

Given below is the explanation of examples of new selection and reselection of an existing object. FIGS. 35 to 37 are diagrams for explaining specific examples of new selection and reselection of an existing object.

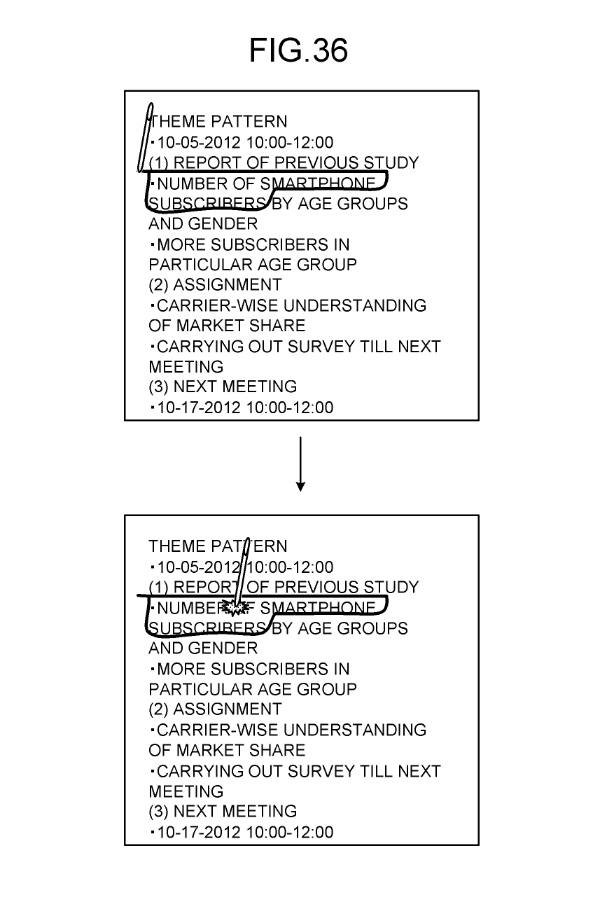

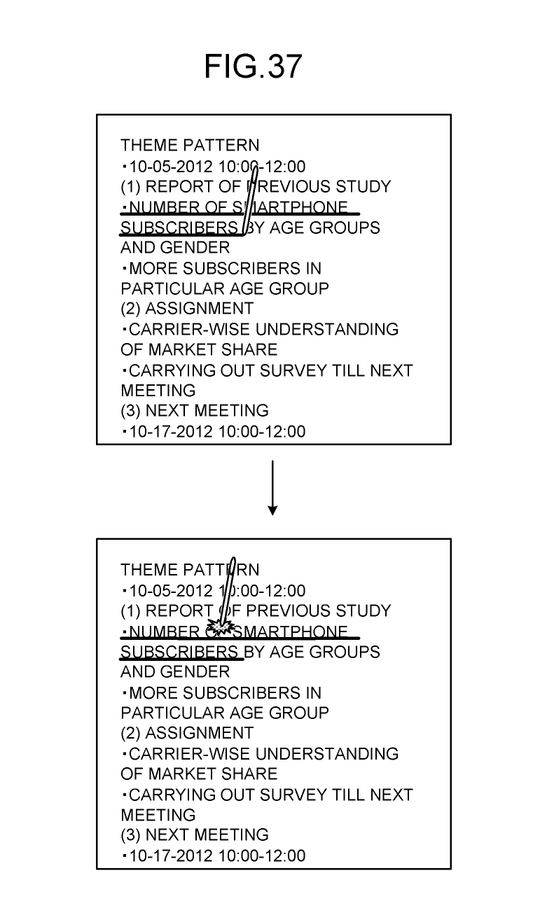

In FIG. 35 is illustrated an example in which an existing object is newly selected by encircling it; and when the inside of the encircled portion (the bounding rectangle of the encircling) is tapped later, the existing object is determined to be reselected. In FIG. 36 is illustrated an example in which an existing object is newly selected by enclosing it in a quadrilateral shape; and when the inside of the enclosed portion (the bounding rectangle of the quadrilateral enclosing) is tapped later, the existing object is determined to be reselected. In FIG. 37 is illustrated an example in which an existing object is newly selected by underlining it; and later the inside of a rectangle formed by expanding the bounding rectangle of the underline is tapped later, the existing object is determined to be reselected. Meanwhile, the display control unit 111 may erase the stroke of tapping (Step S203 illustrated in FIG. 11).

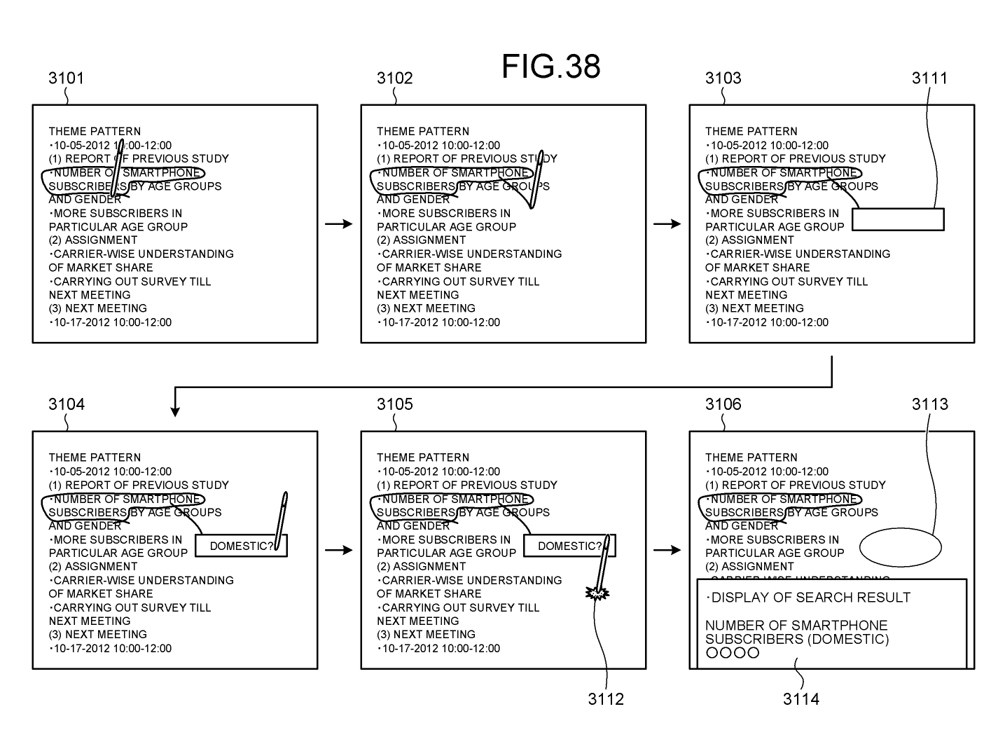

FIG. 38 is a diagram illustrating an exemplary transition of screens when a search command is executed. In FIG. 38, the transition of screens occurs in the order of a screen 3101, a screen 3102, a screen 3103, a screen 3104, a screen 3105, and a screen 3106.

The screen 3101 is an example of the screen in which an existing-object selection command is written. In this case, the mode is updated from “0” to “1”, and “NUMBER OF SMARTPHONE SUBSCRIBERS” is set in obj1. The screen 3102 is an example of the screen in which a relationship command (a lead line) is written. In this case, the mode is updated from “1” to “2”, and the lead line is set in arc. The screen 3103 is an example of the screen in which a writing frame 3111 is displayed with reference to, for example, the end point of the stroke of the relationship command.

The screen 3104 is an example of the screen in which an additional object is written. In this example, the strokes of “DOMESTIC” and “?” are set in the list ST of strokes. The screen 3105 is an example of the screen when completion of writing is notified. For example, completion of writing is detected when the user taps on the outside of the writing frame (Step S6 in FIG. 9). Meanwhile, the display control unit 111 may erase a display 3112 of the stroke of tapping.

The screen 3106 is an example of the screen in which recognition of the additional stroke, execution of a search process, and display of the search result is performed. As a result of recognizing the additional stroke, for example, “DOMESTIC” is set in obj2 and “?” is set in cmd. Accordingly, a search process is performed in which “NUMBER OF SMARTPHONE SUBSCRIBERS” and “DOMESTIC” are treated as the search query. Then, the search result of the search process is displayed in a search result display section 3114. As illustrated in an area 3113 in FIG. 38, after the search process is completed, the display control unit 111 can erase the display of the relationship command (arc), the writing frame, and the additional stroke (ST).

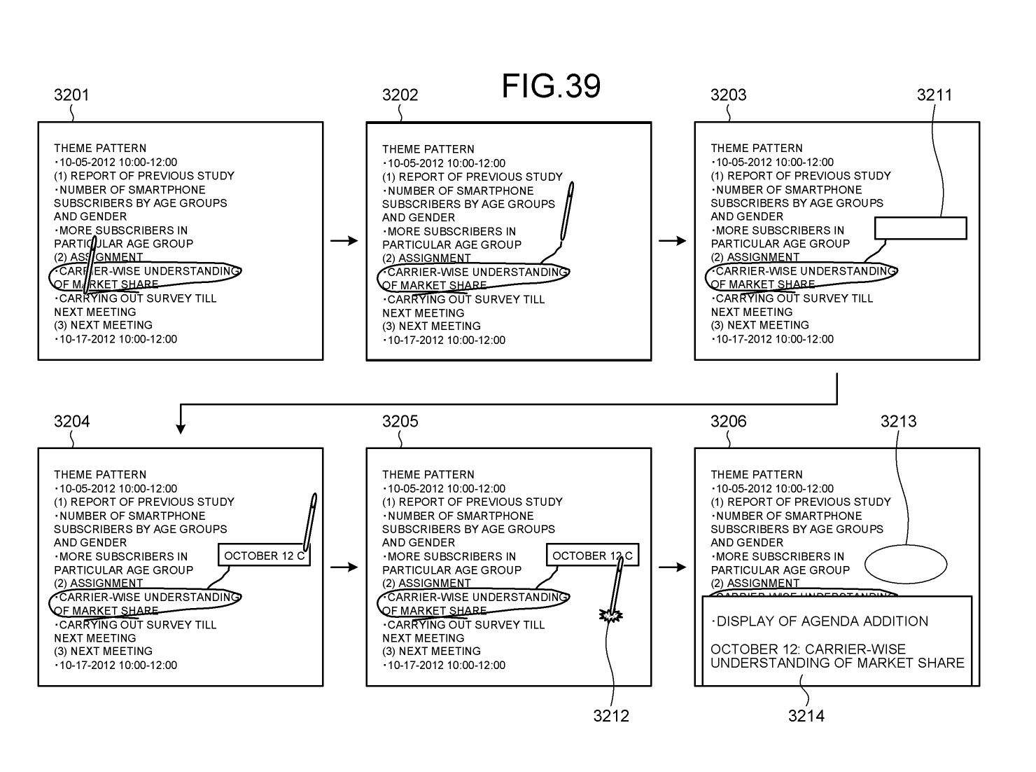

Meanwhile, in addition to the search process described above, the executing unit 115 may also be configured to perform arbitrary processes such as a schedule registering process. FIG. 39 is a diagram illustrating an exemplary transition of screens during a process of adding an agenda to the schedule. In FIG. 39, the transition of screens occurs in the order of a screen 3201, a screen 3202, a screen 3203, a screen 3204, a screen 3205, and a screen 3206.

In the example illustrated in FIG. 39, the strokes of “October 12” and “C” are set in the list ST of strokes. Herein, “C” is an example of a command that indicates adding an object as an agenda of the schedule. Alternatively, a character string or a sign other than “C” may be set as an agenda addition command.

As a result, as illustrated in the screen 3206, a process is performed by which the character string “CARRIER-WISE UNDERSTANDING OF MARKET SHARE” is added as the agenda of October 12. In an identical manner to FIG. 38, the display control unit 111 can erase a display 3212 of the stroke of tapping and erase the display within an area 3213. Moreover, the display control unit 111 can display the agenda addition result in a display section 3214. The object that is added as an agenda may be text data (a character code string) or may be data of handwriting.

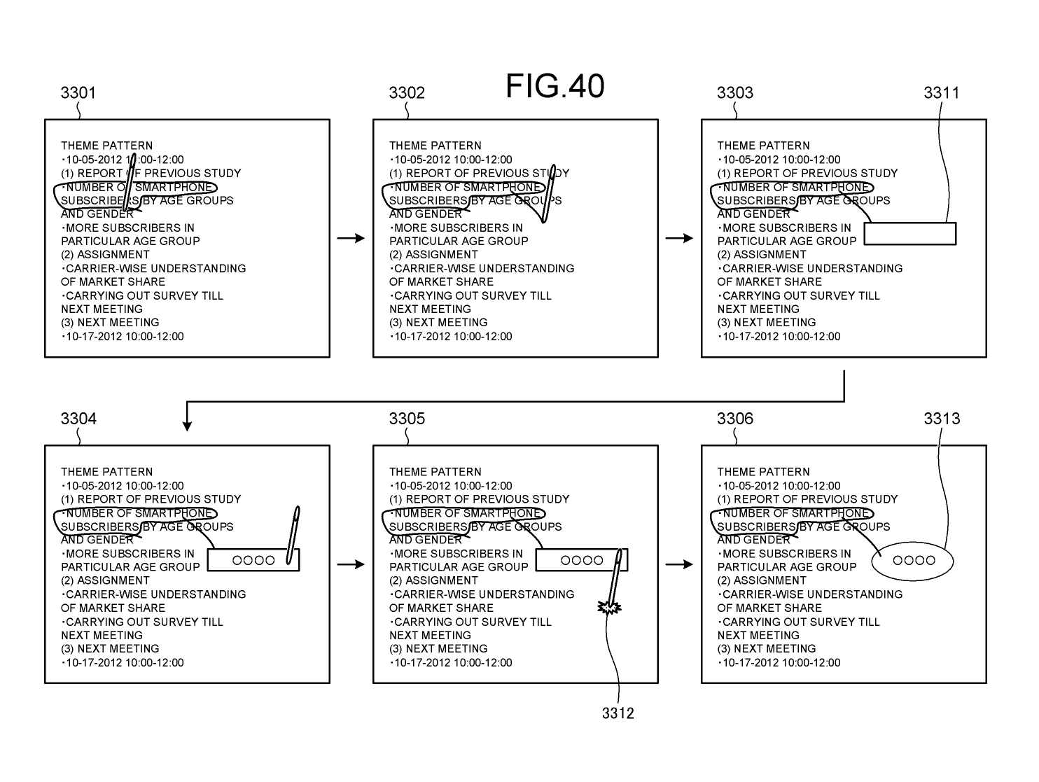

FIG. 40 is a diagram illustrating an exemplary transition of screens when an annotated display is performed. In FIG. 40, the transition of screen occurs in the order of a screen 3301, a screen 3302, a screen 3303, a screen 3304, a screen 3305, and a screen 3306. In FIG. 40 is illustrated an example in which an additional object is determined to be an annotation because, for example, a predetermined run command such as a relationship command (FIG. 38) or an agenda addition command (FIG. 39) was not detected.

The processes with reference to the screen 3301 to the screen 3303 are identical to the processes with reference to the screen 3101 to the screen 3103, respectively, illustrated in FIG. 38. In the screen 3304 is input a character string “0000” not including commands such as “?” and “C”. In this case, if completion of writing is detected, then the additional stroke is recognized (Step S8 in FIG. 9), and “oooo” is set in obj2 and null is set in cmd. The detected object is determined to be an annotation and the annotated display is performed in a display area 3313 (Step S12 in FIG. 9).

The display control unit 111 can erase a display 3312 of the stroke of tapping. Alternatively, the display control unit 111 may change the display mode of the annotated display before displaying it on the display unit 121.

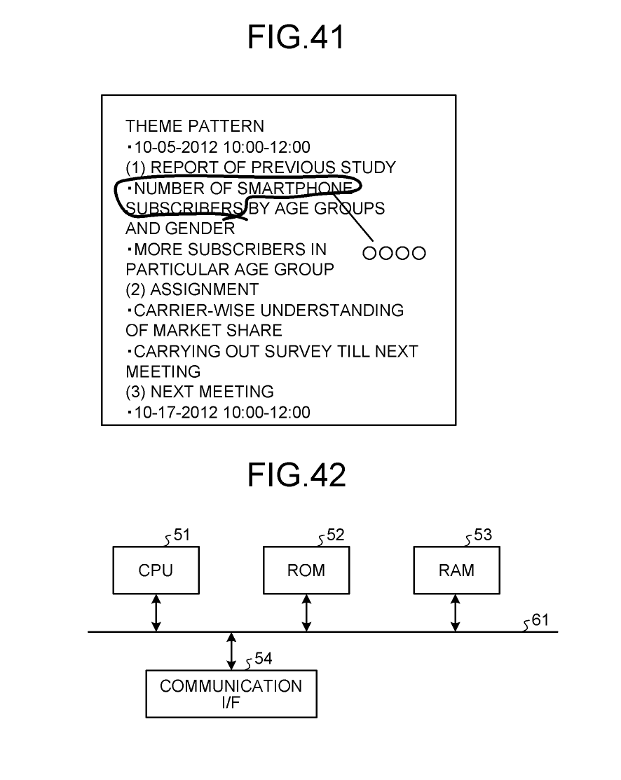

FIG. 41 is a diagram for explaining the method of changing the display mode of the annotated display. In FIG. 41 is illustrated an example in which a lead line that is detected as the relationship command at the time of annotating is formatted to a straight line before being displayed. However, the method of changing the display is not limited to this method. Alternatively, for example, character recognition may be performed with respect to an additional object (handwritten stroke data) that is detected as an annotation, and the character code that is obtained may be displayed in a predetermined font.

In this way, in the information processing device according to the embodiment, processes such as a search process is performed using an existing object detected from the displayed document as well as using an additional object. As a result, processes according to the handwritten input can be performed in a more accurate manner.

Explained below with reference to FIG. 42 is a hardware configuration of the information processing device according to the embodiment. FIG. 42 is an explanatory diagram for explaining a hardware configuration of the information processing device according to the embodiment.

The information processing device according to the embodiment includes a control device such as a central processing unit (CPU) 51 that controls the whole device; storage devices such as a read only memory (ROM) 52 and a random access memory (RAM) 53 that stores a variety of data or a variety of programs; a communication I/F 54 that performs communication by establishing a connection with a network and controls communication with an external device; and a bus 61 that interconnects the other constituent elements.

Meanwhile, the computer programs that are executed in the information processing device according to the embodiment are stored in advance in the ROM 52.

Alternatively, the computer programs that are executed in the information processing device according to the embodiment can be recorded in the form of installable or executable files in a computer-readable recording medium such as a compact disk read only memory (CD-ROM), a flexible disk (FD), a compact disk readable (CD-R), or a digital versatile disk (DVD); and can be provided as a computer program product.

Still alternatively, the computer programs that are executed in the information processing device according to the embodiment can be saved as downloadable files on a computer connected to the Internet or can be made available for distribution through a network such as the Internet.

Meanwhile, the computer programs that are executed in the information processing device according to the embodiment can make a computer function as the constituent elements of the information processing device. In that computer, the CPU 51 reads the computer programs from a computer-readable storage medium and runs them such that the computer programs are loaded in a main storage device.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. An information processing device associated with a display unit displaying information, comprising:
a first detecting unit configured to detect a selection command being input in handwriting to instruct selection of an object included in the information displayed on the display unit, and configured to detect a first object being additionally input in handwriting relating the information;
a second detecting unit configured to detect a second object from among objects included in the information, the second object being instructed to be selected by the selection command; and
an executing unit configured to perform a specified process using the first object and the second object.

2. The device according to claim 1, wherein
the first detecting unit is configured to further detect a run command to instruct execution of a process, the run command being input in handwriting with respect to the information, and
the executing unit performs the process that is instructed to be executed by the run command, using the first object and the second object.

3. The device according to claim 2, further comprising a display control unit configured to display the run command on the display unit, wherein
the display control unit is configured to erase the displayed run command from the display unit after the process is performed.

4. The device according to claim 2, further comprising a display control unit configured to display the run command on the display unit so that a display mode of the run command is different before the process and during the process.

5. The device according to claim 2, wherein the first detecting unit is configured to detect the run command for which a difference between a detection timing of the second object and a handwritten input timing is within a predetermined period of time.

6. The device according to claim 2, wherein the first detecting unit is configured to further
detect a relationship command that indicates establishing relationship with the selection command, the relationship command being input in handwriting with respect to the information, and
detect the run command that is instructed by the relationship command to establish relationship with the selection command.

7. The device according to claim 6, wherein the first detecting unit is configured to detect the run command for which a difference between a detection timing of the relationship command and a handwritten input timing is within a predetermined period of time.

8. The device according to claim 6, wherein the first detecting unit is configured to detect, as the relationship command, a line that has a point present within a predetermined distance from the selection command as an extreme point.

9. The device according to claim 1, wherein the first detecting unit is configured to detect, as the run command, an object that matches with or is similar to a particular pattern.

10. The device according to claim 1, further comprising a display control unit configured to display the selection command on the display unit so that a display mode of the selection command is different before the process and during the process.

11. The device according to claim 1, further comprising a display control unit configured to display the selection command on the display unit so that a display mode of the selection command is different before the process and after the process.

12. The device according to claim 1, wherein the second detecting unit is configured to detect, as the second object, an object for which a degree of overlapping with an area specified by a handwritten input is equal to or greater than a predetermined threshold value from among objects included in the information.

13. An information processing method comprising:
detecting a selection command being input in handwriting to instruct selection of an object included in information displayed on a display unit;
detecting a first object being additionally input in handwriting relating the information;
detecting a second object from among objects included in the information, the second object being instructed to be selected by the selection command; and
performing a specified process using the first object and the second object.

14. A computer program product comprising a computer-readable medium containing a program executed by a computer, the program causing the computer to execute:
detecting a selection command being input in handwriting to instruct selection of an object included in information displayed on a display unit;
detecting a first object being additionally input in handwriting relating the information;
detecting a second object from among objects included in the information, the second object being instructed to be selected by the selection command; and
performing a specified process using the first object and the second object.
